(19) United States
(12) Patent Application Publication
(10) Pub. No.: US 2025/0324354 A1
(43) Pub. Date: Oct. 16, 2025

(54) FEATURE CONTEXT SPECIFIC SYSTEM INFORMATION UPDATE

(71) Applicant: QUALCOMM Incorporated, San Diego, CA (US)

(72) Inventors: Sambit BEHURA, Hyderabad (IN); Hemasagar MISHRA, Balangir (IN); Ishdeep Singh JUNEJA, Hyderabad (IN); Varun WALIA, Hyderabad (IN); Nazmul ISLAM, Littleton, MA (US)

(21) Appl. No.: 18/631,975

(22) Filed: Apr. 10, 2024

(51) Int. Cl. H04W 48/16; H04W 48/12

(52) U.S. Cl. CPC H04W 48/16; H04W 48/12

(57) ABSTRACT

Certain aspects of the present disclosure provide techniques for feature context specific system information update. A method for wireless communications by a user equipment (UE) includes receiving system information configuring a feature combination configuration. The method includes receiving signaling indicating an update to the feature combination configuration. The method includes, in response to the indication, monitoring a search space for signaling indicating the updated feature combination configuration.

### FIELD OF THE DISCLOSURE

Aspects of the present disclosure relate to wireless communications, and more particularly, to techniques for feature context specific system information update.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving system information configuring a feature combination configuration; receiving signaling indicating an update to the feature combination configuration; and monitoring, in response to the indication, a search space for signaling indicating the updated feature combination configuration.

Another aspect provides a method for wireless communications by a network entity. The method includes outputting system information configuring a user equipment (UE) with a feature combination configuration; outputting signaling indicating an update to the feature combination configuration; and outputting signaling indicating the updated feature combination configuration.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example call flow illustrating feature-configuration update.

FIG. 6 depicts an example new short message format for feature-context-specific configuration update.

FIG. 7 depicts an example new short message indicator format for feature-context-specific configuration update.

FIG. 8 depicts an example downlink control information (DCI) format including the new short message indicator and new short message for feature-context-specific configuration update.

FIG. 9 depicts an example DCI format for dynamic feature-combination preamble (FCP) partition update.

FIG. 10 depicts a process flow for communications in a network between a network entity, a feature-UE, and a non-feature-UE for context-specific configuration update without feature filtering.

FIG. 11 depicts a process flow for communications in a network between a network entity, a feature-UE, and a non-feature-UE for context-specific configuration update with feature filtering.

FIG. 12 depicts a process flow for communications in a network between a network entity, a feature-UE, and a non-feature-UE for FCP partition update.

FIG. 13 is a diagram illustrating operations for FCP partition update, feature-context-specific configuration update without feature filtering, and feature-context-specific configuration update with feature filtering.

FIG. 14 depicts a method for wireless communications.

FIG. 15 depicts a method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for feature context specific system information update.

User equipment (UE) may support a number of features, or feature combinations, and such UEs may be referred to as “feature-UEs.” In new radio (NR), features may include reduced capability (RedCap), feature combination preamble (FCP) partitioning, small data transmission (SDT), and other features. Future systems may define additional new features and feature combinations. Feature-UEs may be configured with feature-context-specific configurations in system information from the network, such as the initial system information block (SIB1).

Currently, to update the feature-context-specific configuration, the network sends downlink control information (DCI), specifically in 3GPP systems a DCI format 1_0 with a cyclic redundancy check (CRC) scrambled with a physical radio network temporary identifier (P-RNTI), with a short message indicating a system information modification, to all registered UEs. The network then transmits another DCI, specifically in 3GPP systems a DCI format 1_0 with CRC scrambled by a system information RNTI (SI-RNTI), scheduling a physical downlink shared channel (PDSCH) carrying the updated SIB1. Because the registered UEs all received the short message, the UEs all monitor the second DCI and the SIB1. However, in cases where the system information update only includes modifications to the feature-context-specific configuration, the configuration is not applicable to non-feature-UEs that receive updated system information, leading to inefficiencies for those UEs.

Accordingly, techniques, systems, and apparatus for feature-context-specific configuration updates are desirable.

According to certain aspects, a new short message is provided with a new field that indicates that the system information update is applicable only to feature-UEs, allowing non-feature-UEs to ignore (not attempt to decode) the system information update.

According to certain aspects, a new short message indicator (or new interpretation of the short message indicator bits) can indicate the system information update is for FCP partition modification only, is for other feature-specific configuration modifications with feature filtering, or is for other feature-specific configuration modifications without feature filtering.

According to certain aspects, where the new short message indicator indicates that the system information update is for FCP partition modification only, the feature-UEs may monitor for a new DCI format, for example, a DCI format 1_0 with a CRC scrambled with a feature specific RNTI (FS-RNTI), that carries the FCP partition modification, which may be faster than updating via SIB1. According to certain aspects, the feature-UEs monitor a new search space, for example a feature search space, for the new DCI format. According to certain aspects, the new DCI format includes a continuity bit. For example, the new DCI format may carry FCP partition modification for a single FCP partition. Where there are multiple FCP partitions to be modified, the network may sends multiple transmissions of the new DCI format carrying the updates for the multiple FCP partitions. Accordingly, the network may set the continuity bit to indicate additional DCIs will be transmitted until there are new further DCI to be transmitted.

According to certain aspects, where the new short message indicator indicates that the system information update is for other feature-specific configuration modifications with feature filtering, the feature-UEs may decode a new paging message indicating the particular features for which the feature-specific configuration modification is applicable. Based on the indicated features, feature-UEs that support one or more of the indicated features may continue to attempt to decode the system information update, while feature-UEs that do not support any of the indicated feature may ignore the system information update (e.g., decode the DCI format 1_0 with CRC scrambled by SI-RNTI and the PDSCH carrying updated SIB1).

According to certain aspects, where the new short message indicator indicates that the system information update is for other feature-specific configuration modifications without feature filtering, the feature-UEs may continue to attempt to decode the system information update (e.g., decode the DCI format 1_0 with CRC scrambled by SI-RNTI and the PDSCH carrying updated SIB1).

Accordingly, system information update may be improved for feature-context-specific configuration updates to prevent non-feature-UEs from, and/or feature-UEs not supporting applicable features, from unnecessarily decoding the system information update when the update is not applicable to those UEs. Further, FCP partition configuration may be performed using DCI, which may reduce the time for update as compared to update by SIB.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

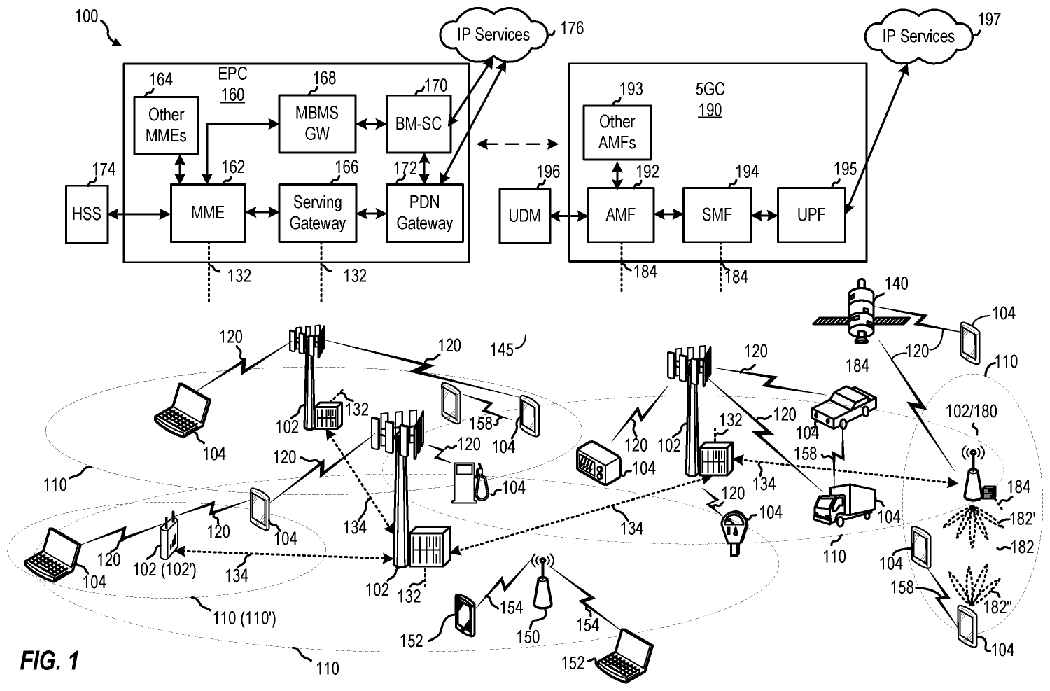

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

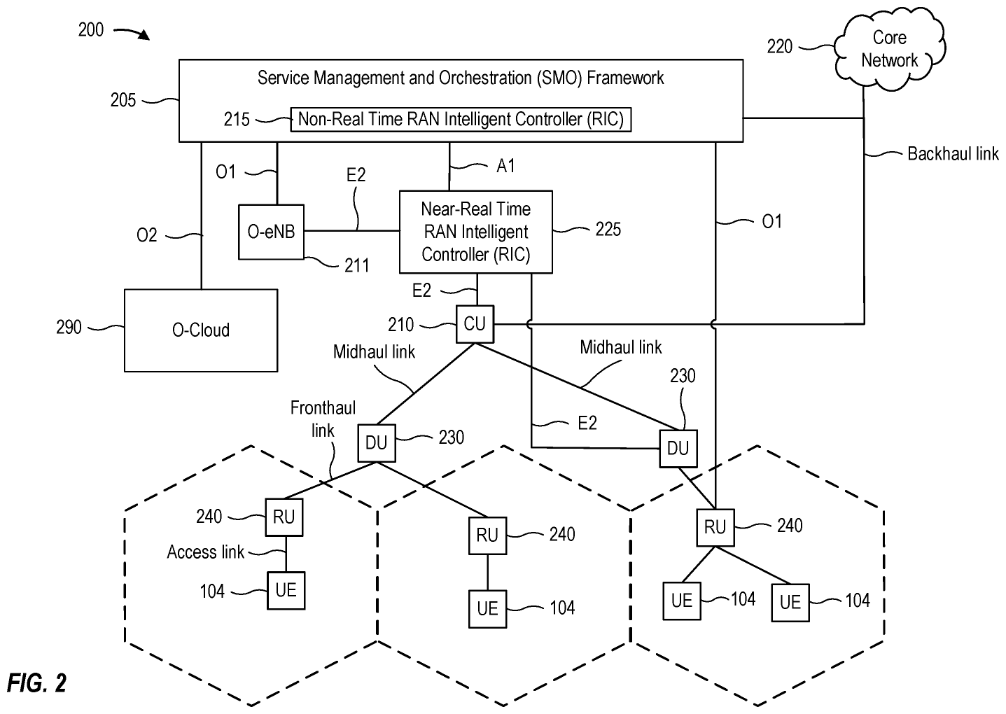

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an 02 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

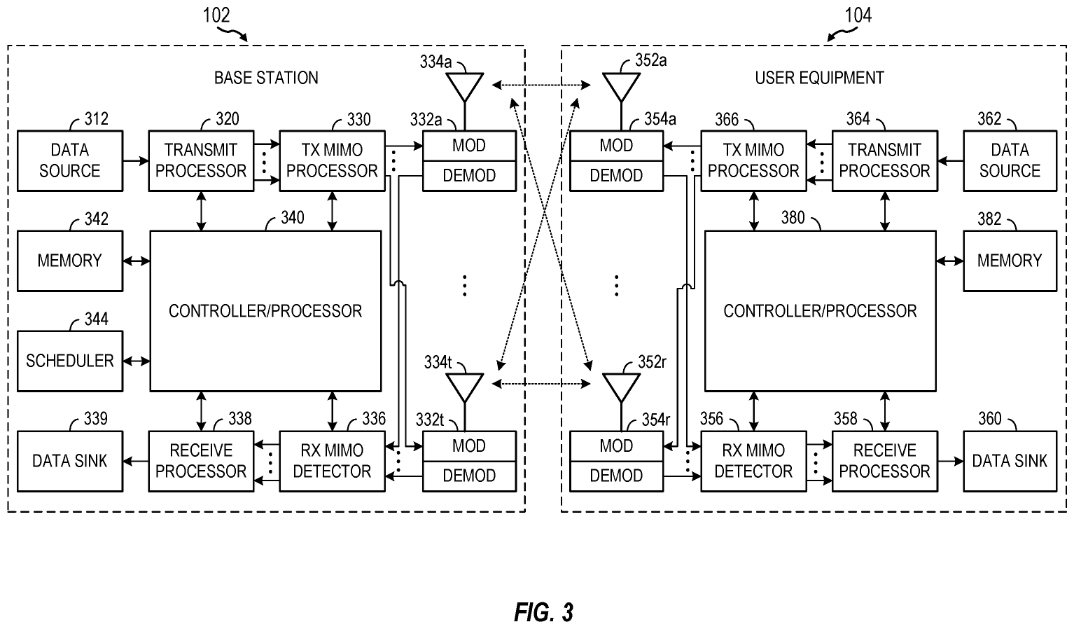

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

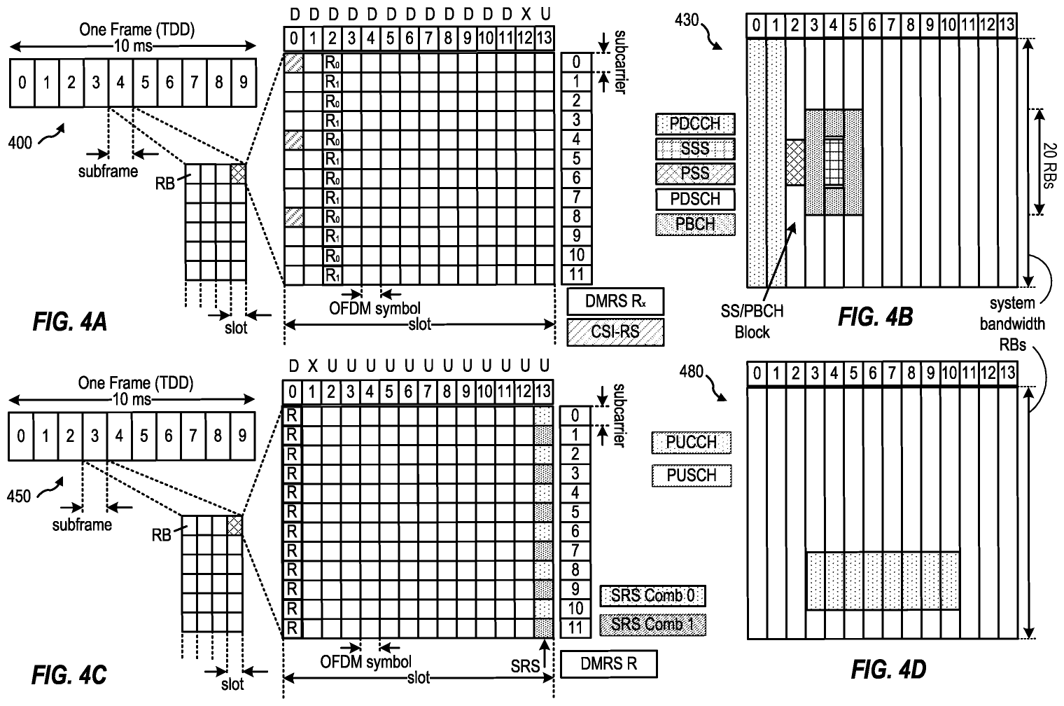

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Feature-UEs

In certain wireless communication systems, such as 5G NR Release-17 systems and 5G NR Release-18 systems, include “feature-UEs” which are UEs that support specific combinations of features. These features may include reduced capability (RedCap), enhanced RedCap (e-RedCap), small data transmission (SDT), network slice as group (NSAG), non-terrestrial network (NTN), feature-combination-preambles (FCP), and/or other features. Future wireless communication systems, such as 6G systems and beyond, may further expand the list of available features and address new use cases.

In some aspects, a feature-UE may be configured with a feature-context-specific configuration. A feature or combination of features may be indicated by a FeatureCombination IE. The feature-UE may receive an initial system information block (e.g., SIB1) including the feature-context-specific configuration. In some aspects, a SIB1 includes one or more configuration parameters that are common to both feature-UEs and non-feature-UEs, such as a cellSelectionInfo information element (IE), a si-SchedulingInfo IE, a ue-TimersAndConstants IE, and a servingCellConfigComm on IE. The servingCellConfigCommon IE may include the feature-context-specific configuration applicable only to feature-UEs. For example, the servingCellConfigCommon IE may include a featurePriorities IE, a redCapPriority IE, slicePriority IE, a msg3-Repetitions-Priority IE, an sdt-Priority IE, a msg1-Repetitions-Priority IE, an eRedCapPriority IE, an Initial-Downlink/uplink-BWP-RedCap IE, a FeatureCombination Preambles IE, a sdt-ConfigCommon IE, a redCap-ConfigCommon IE, and/or additional IEs.

### Aspects Related to Feature-Combination-Preambles

One feature that may be supported by feature-UEs is feature-combination preambles (FCP). With FCP, the total number of RACH preambles may be partitioned among different features. In some aspects, the total number of RACH preambles may be configured by a parameter “totalnumberofRA-Preambles.” Different feature-UEs supporting different combinations of features may use different RACH preambles associated with the supported combination of features. The RACH preamble used by the feature-UE may indicate the supported combination of features to the network. For example, the RACH preamble may be used for RACH message 1 (MSG1) based early-identification of the feature-UEs during initial RACH.

In some aspects, FCP is configured in a RACH-ConfigCommon IE in SIB1. The feature CombinationPreamblesList IE may configure a list of partitions, each of the partitions associated with a configuration the configured by FeatureCombinationPreambles IE and the featureCombination IE lists the features associated with the FeatureCombinationPreambles IE. For example, in 5G NR, up to 256 FCP partitions may be supported. The FeatureCombinationPreambles IE may associate a set of preambles with a feature combination. For example, 3GPP TS 38.331 Section 6.3.2 specifies an example FeatureCombinationPreambles IE including a feature Combination field, a startPreambleForThisPartition field, a numberOfPreamblesPerSSB-ForThisPartition field, and an ssb-SharedRO-MaskIndex field. The featureCombination field may indicate which combination of features that the preambles indicated by the FeatureCombination Preambles IE are associated with. The UE may ignore a RACH resource defined by the FeatureCombinationPreambles if any feature within the featureCombination field is not supported by the UE. The numberOfPreamblesPerSSB-ForThisPartition field may determine how many consecutive preambles are associated to the Feature Combination starting from the starting preamble(s) per synchronization signal block (SSB).

### Aspects Related to Feature-Combination Configuration Update

In certain systems, any update to the feature-context-specific configuration, including FCP updates, is by a SIB1 update using a short message. For example, 3GPP TS 38.331 Section 5.2.2.2.2 specifies that the UE receives indications about system information modifications using a short message transmitted in DCI with a cyclic redundancy check (CRC) scrambles by a physical radio network temporary identifier (P-RNTI). The UEs may monitor for the short message in one or more PDCCH monitoring occasions in one or more paging occasions.

Short messages may be transmitted on PDCCH using P-RNTI with or without an associated message. In some aspects, the short messages may be transmitted in a short message field in a DCI format 1_0. For example, 3GPP TS 38.212 Section 7.3.1.2.1 specifies an example DCI format 1_0. The DCI format 1_0 may be used for the scheduling of PDSCH in a downlink cell.

A DCI format 1_0 with CRC scrambled by P-RNTI may include a short message indicator (e.g., a 2 bit field). The bit values of the short message indicator fields may be interpreted as: 00, reserved; 01, only scheduling information for paging, and tracking reference signal (TRS) availability indication if trs-ResourceSetConfig is configured, are present in the DCI; 10, only short message, and TRS availability indication if trs-ResourceSetConfig is configured, are present in the DCI; and 11, both scheduling information for paging, TRS availability indication if trs-ResourceSetConfig is configured and short message are present in the DCI.

The DCI format 1_0 with CRC scrambled by P-RNTI may further include a short messages field (e.g., an 8 bit field). The bit values of the short messages field may be interpreted as follows: bit 1 is a systemInfoModification bit, if set to 1: indication of a broadcast control channel (BCCH) modification other than SIB6, SIB7, SIB8, and posSIBs; bit 2 is an etwsAndCmasIndication bit, if set to 1: indication of an Earthquake and Tsunamic Warning System (ETWS) primary notification and/or an ETWS secondary notification and/or a Commercial Mobile Alert Service (CMAS) notification; bit 3 is a stopPagingMonitoring bit that may be used for operation with shared spectrum channel access and if a nrofPDCCH-MonitoringOccassionPerSSB-InPO is present, if set to 1: indication that the UE may stop monitoring PDCCH occasion(s) for paging in this paging occasion; bit 4 is a systemInfoModification-eDRX bit that may only apply to UEs using an IDLE enhanced discontinuous reception (eDRX) cycle longer than the BCCH modification period, if set to 1: indication of a BCCH modification other than SIB6, SIB7, SIB8 and posSIBs; and bits 5-8 unused and ignored by the UE if received.

If the UE receives the DCI format 1_0 carrying the short message with the systemInfoModification of the short messages field set (e.g., to ‘1’), the UE may apply a system information acquisition procedure at the start of the next modification period (e.g., according to TS 38.331 Section 5.2.2.3). For example, the gNB may transmit a DCI format 1_0 with CRC scrambled by SI-RNTI and a system information indicator indicating SIB1. The DCI contains scheduling information for a PDSCH carrying the updated SIB1. The UE may monitor a SIB1 search space for the DCI format 1_0 with CRC scrambled by SI-RNTI.

The short message is paged to all registered UEs, which may include both feature-UEs and also non-feature-UEs. In this case, both the feature-UEs and non-feature-UEs will monitor for an updated SIB1. However, where the updated SIB1 only updates the feature-context-specific configuration, the updated SIB1 is only applicable to the feature-UEs, thereby wasting overhead for the non-feature-UEs for which the SIB1 is not applicable. For example, the non-feature-UEs decoding of the updated SIB1 leads to unnecessary idle-mode activity and wake-up for the non-feature-UEs to monitor the SIB1 search space and attempt to decode the updated SIB1 payload.

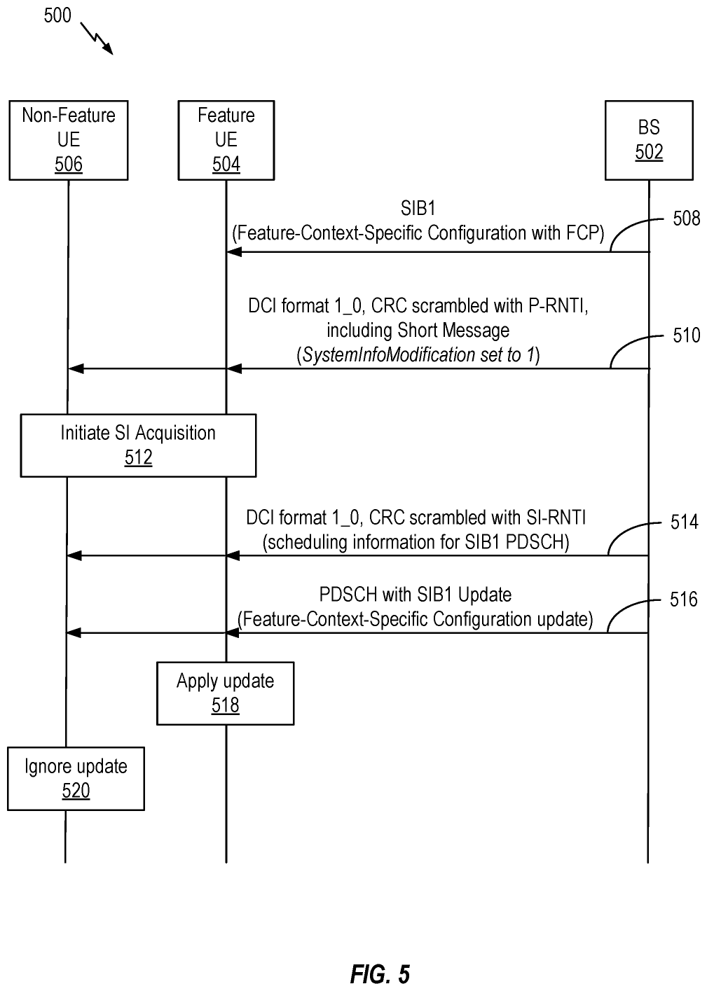

FIG. 5 depicts an example call flow 500 illustrating feature-configuration update. As shown, at operation 508, BS 502 sends a SIB1 with a feature-context-specific configuration, which may include an FCP configuration. To update the feature-context-specific configuration, at operation 510, the BS 502 sends a DCI format 1_0 with CRC scrambled with P-PRNTI that carries a short message with the SystemInfoModification bit set indicating an update to system information. As shown, the DCI is received by both the feature-UE 504 and the non-feature-UE 506. Although the feature-context-specific configuration update is applicable only to the feature-UE 504, both the feature-UE 504 and the non-feature-UE 506 initiate an SI acquisition procedure at operation 512. At operation 514, the BS 502 sends a DCI format 1_0 with CRC scrambled with SI-RNTI scheduling a PDSCH for SIB1 update. This DCI may also be monitored and received by both the feature-UE 504 and the non-feature-UE 506. Accordingly, both the feature-UE 504 and the non-feature-UE 506 may monitor and receive the PDSCH with the SIB1 carrying the updated feature-context-specific configuration at operation 516. Because the updated feature-context-specific configuration is applicable only to the feature-UE 504, at operation 518 the feature-UE 504 applies the update and at operation 520 the non-feature-UE 506 ignores the update.

Accordingly, techniques for updating feature-context-specific configuration information for feature-UEs while avoiding overhead to the non-feature-UEs are desirable.

In addition, in certain systems (e.g., 5G system), FCP partitions are a static configuration in SIB1. In some systems (e.g., 6G systems and later), however, FCP partitions may be dynamic. Dynamic FCP may provide for more efficient user management, depending on the number of active users per feature. For example, the gNB may dynamically modify the FCP partitions to allocate more preambles for a feature that has more registered users, as compared to other feature users. Modification of the FCP partitions via the short message SIB1 update may be a slow, RRC-signaling based, process. Accordingly, techniques for faster dynamic updating of the FCP partitions are desirable.

### Aspects Related to Feature-Context-Specific Configuration Update

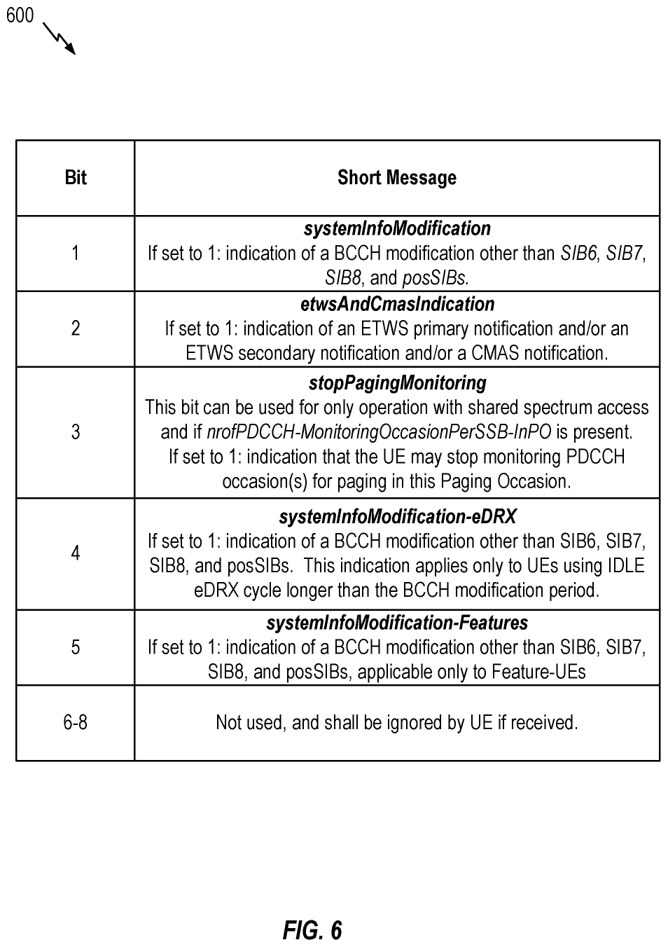

According to certain aspects, techniques are provided for a feature-UE specific system information update. In some aspects, feature-UEs can be paged separately from non-feature-UEs for system information updates. For example, a new short message may be provided for feature-UEs. In some examples, the new short message includes a field that indicates the short message is only for feature-UEs. For example, one or more of the reserved bits of the existing short message (e.g., bit #5) carried in the DCI format 1_0 with CRC scrambled by the P-RNTI may be used to indicate the short message is only for feature-UEs. In some examples, the field is a “systemInfoModification-Features” field. The field may be set to “1” to indicate that a BCCH modification is applicable only to feature-UEs. An example new short message format 600 is depicted in FIG. 6. Although one short message format 600 is illustrated in FIG. 6, a new short message format may include different fields, different numbers of bits, and/or different ordering of the fields than the example new short message format 600.

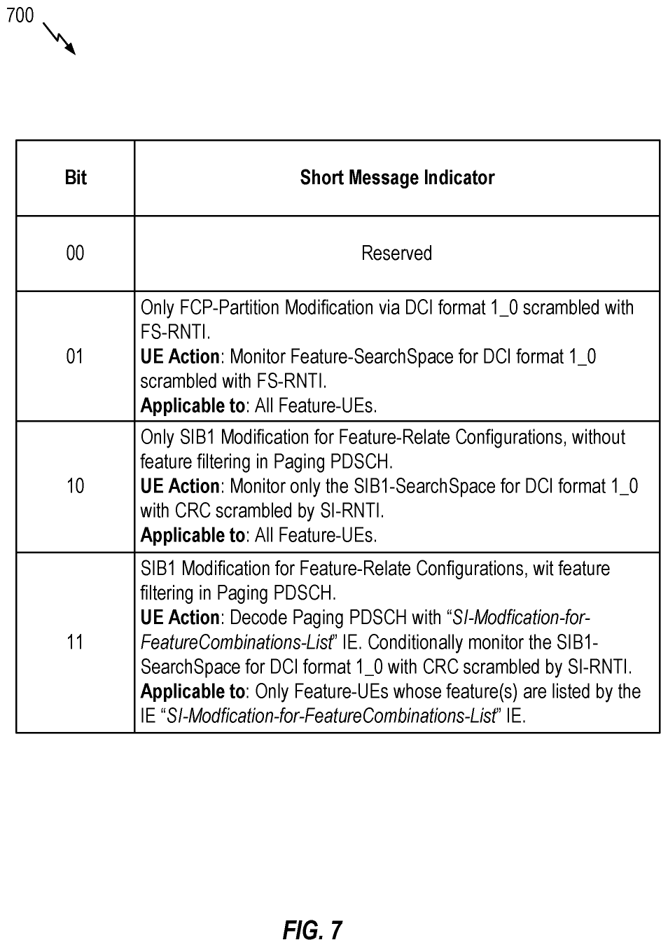

In some aspects, where only the feature-context-specific configuration is being updated, the network further provides an indication in the short message indicator carried in the DCI with the short message. An example new short message indicator format 700 is depicted in FIG. 7. Although one short message indicator format 700 is illustrated in FIG. 7, a new short message indicator format may include different numbers of bits and/or different interpretations of the particular bit values than the example new short message indicator format 700. According to certain aspects, the UE may interpret the bit values (or bit fields) of the short message indicator depending on the whether the new short message format 600 indicates the short message is only for feature-UEs. That is, in some aspects, the new short message indicator format 700 may correspond to a new interpretation of the existing short message indicator format. In some aspects, the UE interprets the bit values as shown in the new short message indicator format 700 in response to the “systemInfoModification-Features” field of the new short message format 600 being to set to “1”.

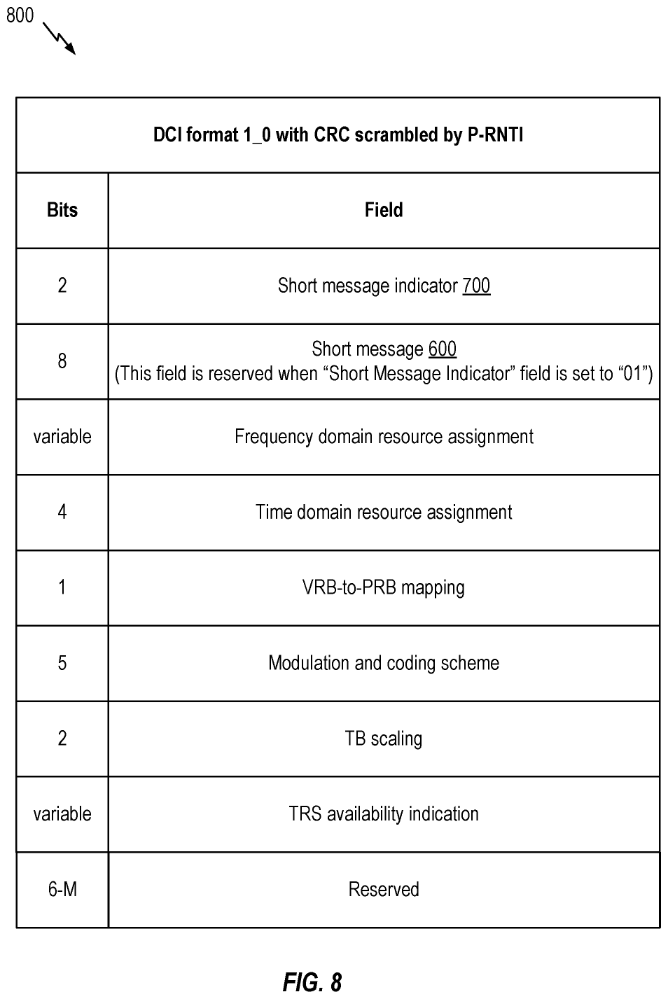

FIG. 8 depicts an example DCI format 800 including the new short message indicator format 700 and new short message format 600. The DCI format 800 may be a new DCI format 1_0 with the CRC scrambled by P-RNTI. Although one DCI format 800 is illustrated in FIG. 8, a DCI format including the new short message indicator format 700 and new short message format 600 may include different fields, different numbers of bits and/or fields, and/or different ordering of the fields than the example DCI format 800.

As shown in FIG. 7, the short message indicator may be set to a first bit value (e.g., “10”) to indicate only the short message is present in the DCI. Feature-UEs that decode the new short message monitor and receive updated system information, while the non-feature-UEs that decode the new short message will ignore (e.g., not attempt to decode) the updated system information to avoid wasted overhead for the non-feature-UEs.

According to certain aspects, the feature-UEs monitor SIB1 search space for a DCI scheduling the SIB1 update. For example, the feature-UEs may monitor for a DCI format 1_0 with the CRC scrambled by SI-RNTI. The DCI format 1_0 with the CRC scrambled by SI-RNTI may schedule a PDSCH carrying a SIB1 having a payload with the feature-context-specific configuration update information.

According to certain aspects, a further feature filtering may be performed. In order to filter feature-UEs that monitor for the SIB1 update based on whether a particular feature (or feature list) is applicable for a given feature-UE, the network may set the short message indicator to a second bit value (e.g., “11”). As shown in the example new short message indicator format 700, the short message indicator with the bit value “11” may indicate for the feature-UE to decode a new paging message (e.g., Paging PDSCH). In some aspects, the new paging message indicates the particular features for which the feature-specific-context configuration is being updated. In some aspects, the new paging message includes a new RRC IE, “SI-Modification-for-FeatureCombination-List”, that indicates the features to which the update applies.

In some aspects, the new paging message has the following format:

-- ASN1START
-- TAG-PAGING-START

| | |
|---|---|
| Paging ::= | SEQUENCE { |
| pagingRecordList | PagingRecordList |

OPTIONAL, -- Need N

| | |
|---|---|
| lateNonCriticalExtension | OCTET STRING |

OPTIONAL,

| | |
|---|---|
| nonCriticalExtension | Paging-v1700-IEs |

OPTIONAL

| | |
|---|---|
| SI-Modification-for-FeatureCombination-List | AppliedFeaturesList |

OPTIONAL
}
-- TAG-PAGING-STOP
-- ASN1STOP

Although an example format for the new paging message is described, the new paging message may have a different format, including one or more different parameters.

In some aspects, the applied features list IE has the following format:

| -- ASN1START | |
|---|---|
| -- TAG-APPLIEDFEATURESLIST-START | |
| AppliedFeaturesList :: = SEQUENCE { | |
| redCap-r17 | ENUMERATED {true} OPTIONAL, -- |
| Need R | |
| e-redCap-r18 | ENUMERATED {true} OPTIONAL, |
| -- Need R | |
| smallData-r17 | ENUMERATED {true} OPTIONAL, |
| Need R | |
| nsag-r17 | ENUMERATED {true} OPTIONAL, |
| --Need R | |
| msg3-Repetitions-r17 | ENUMERATED {true} OPTIONAL, |
| -- Need R | |
| msg1-Repetitions-r18 | ENUMERATED {true} OPTIONAL, |
| -- Need R | |
| spare3 (6G-New-Feature X) | ENUMERATED {true} OPTIONAL, |
| -- Need R | |
| spare2 (6G-New-Feature Y) | ENUMERATED {true} OPTIONAL, |
| -- Need R | |
| spare1 (6G-New-Feature Z) | ENUMERATED {true} OPTIONAL, |

```
  -- Need R
      }
-- TAGAPPLIEDFEATURESLIST-STOP
-- ASN1STOP
```

Although an example format for the applied features list IE is described, the applied features list IE may have a different format, including one or more different parameters.

The feature-UE upon decoding the new paging message payload may determine whether any features listed as “True” in the applied features list are applicable to features of the feature-UE. As indicated by the second bit value (e.g., “11) in the short message indicator format 700, the feature-UE will conditionally attempt to decode the SIB update if the feature-UE has feature(s) included in the applied features list. For example, the UE only monitor the SIBI search space for the DCI format 1_0 with CRC scrambled with the SI-RNTI if a feature supported by the feature-UE is indicated in the “SI-Modification-for-FeatureCombination-List” IE.

According to certain aspects, techniques are provided for a faster dynamic updating of feature-combination-preambles (FCP). In some aspects, where only the FCP partition configuration is being updated, the network sets the new field in the short message format 600 to “1” to indicate feature-context-specific configuration modification for feature-UEs and sets the new field in the short message indicator format 700 to a third value (e.g., “01”) to indicate the FCP partition update.

In some aspects, a new RNTI (e.g., different than P-RNTI) may be used to scramble CRC for DCI used to dynamically update the FCP configuration. The new RNTI may be a feature-specific RNTI (FS-RNTI) defined for dynamic FCP update. In some aspects, the DCI format 1_0 with the CRC scrambled by the FS-RNTI is used for FCP partition update.

In some aspects, the third value in the short message indicator format 700 indicates for the feature-UE to monitor a new search space. For example, the new search space may be a feature search space. In some aspects, a new RRC IE “Feature-SearchSpace” is provided in PDDCH-ConfigCommon to configure a Type2B-PDCCH Common-SearchSpaceSet to monitor for the DCI format 1_0 with CRC scrambled by FS-RNTI.

In some aspects, the PDCCH-ConfigCommon IE has the following format:

-- ASN1START
-- TAG-PDCCH-CONFIGCOMMON-START

| | |
|---|---|
| PDCCH-ConfigCommon ::= | SEQUENCE { |

| | |
|---|---|
| controlResourceSetZero | ControlResourceSetZero |

OPTIONAL, -- Cond InitialBWP-Only

| | |
|---|---|
| commonControlResourceSet | ControlResourceSet |

OPTIONAL, -- Need R

| | |
|---|---|
| searchSpaceZero | SearchSpaceZero |

OPTIONAL, -- Cond InitialBWP-Only

| | |
|---|---|
| commonSearchSpaceList | SEQUENCE (SIZE(1..4)) OF SearchSpace |

OPTIONAL, -- Need R

| | |
|---|---|
| searchSpaceSIB1 | SearchSpaceId |

OPTIONAL, -- Need S

| | |
|---|---|
| searchSpaceOtherSystemInformation | SearchSpaceId |

OPTIONAL, -- Need S

| | | |
|---|---|---|
| pagingSearchSpace | SearchSpaceId | OPTIONAL, |

-- Need S

| | | |
|---|---|---|
| ra-SearchSpace | SearchSpaceId | OPTIONAL, |

-- Need S

| | |
|---|---|
| Feature-SearchSpace | SearchSpaceId |

OPTIONAL, -- Need S
...,
-- TAG-PDCCH-CONFIGCOMMON-STOP
-- ASN1STOP

Although an example format for the PDCCH-ConfigCommon IE is described, the PDCCH-ConfigCommon IE may have a different format, including one or more different parameters.

In some aspects, the modification period for FCP partition modifications via the DCI format 1_0 with CRC scrambled by FS_RNTI is the same as that indicated by a parameter, “modificationPeriodCoeff”, in the “BCCH-Config” IE in the SIB1 IE “DownlinkConfigCommonSIB.”

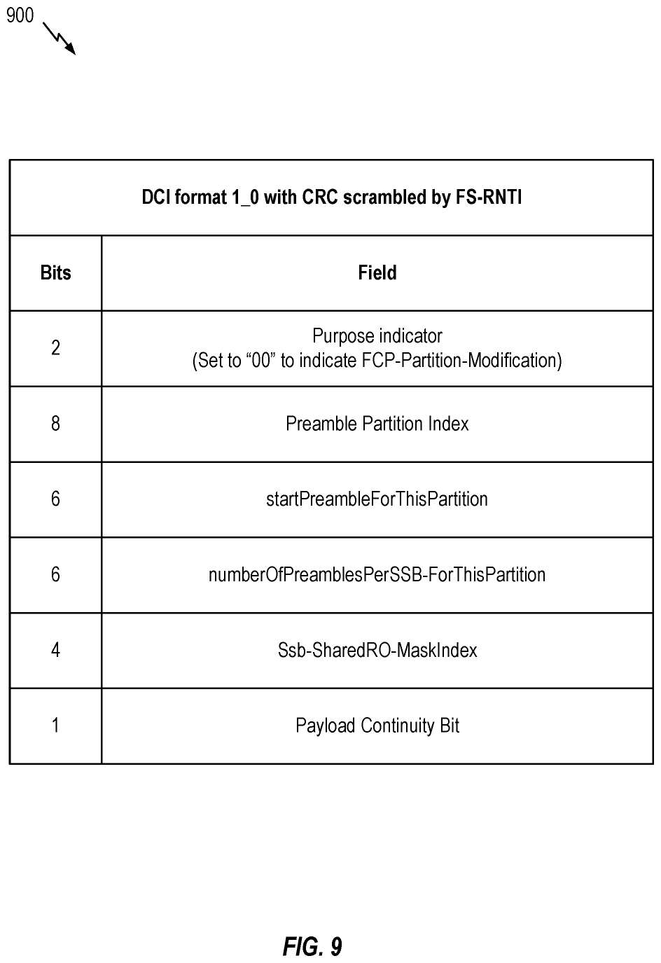

FIG. 9 depicts an example DCI format 900 for dynamic FCP partition update. As shown, the DCI format 900 may be the DCI format 1_0 with the CRC scrambled by the FS-RNTI. As shown, the DCI format 900 may include a purpose indicator (e.g., a 2-bit field). A bit value (e.g., “00”) of the purpose indicator may indicate that the DCI is for FCP partition modification. Other bit values (e.g., “01”, “10”, and “11”) of the purpose indicator may be reserved.

In some aspects, each DCI format 900 updates the configuration for one FCP partition. As shown, the DCI format 900 may include a preamble partition index (e.g., an 8-bit field). The preamble partition index may indicate an index (e.g., 1-256) pointing to a configured FCP partition (e.g., configured in the FeatureCombinationPreambles-List).

In some aspects, the DCI format 900 indicates the selected preambles for the FCP partition. As shown, the DCI format 900 may include a “startPreambleForThisPartition” (e.g., a 6-bit field) indicating a starting preamble and a “numberOfPreamblesPerSSB-ForThisPartition” (e.g., a 6-bit field) indicating a number of preambles.

In some aspects, the DCI format 900 indicates PRACH occasions that belong to the FCP partition. As shown, the DCI format 900 may include a “ssb-SharedRO-MaskIndex” (e.g., a 4-bit field). The index may map to allowed PRACH occasions. For example, TS 38.321 Section 7.2, Table 7.4-1, depicts an example mapping of the index to allowed PRACH occasions.

The preamble partition index, startPreambleForThisPartition, numberOfPreamblesPerSSB-ForThisPartition, and ssb-SharedRO-MaskIndex fields convey the modification for the FCP partition.

In some aspects, the DCI format 900 further includes a payload continuity bit. For example, where the DCI format 900 is used to update a single FCP partition, the payload continuity bit may be used to indicate whether are additional DCIs to modify additional FCP partitions or whether the FCP partition update is completed. For example, where the payload continuity bit is set to “1”, the feature-UE may continue to monitor for the DCI format 900 until the feature-UE receives a DCI format 900 with the payload continuity bit set to “0.”

Although one DCI format 900 for dynamic FCP partition update is illustrated in FIG. 9, a DCI format for dynamic FCP partition update may include different fields, different numbers of bits and/or fields, and/or different ordering of the fields than the example DCI format 900.

A quicker, DCI-based, dynamic update may allow for faster congestion resolution. In some aspects, the network may choose between FCP update via the new RNTI DCI, via the SIB1 update, or via both the new RNTI DCI and the SIB1 update.

### Example Operations of Entities in a Communications Network

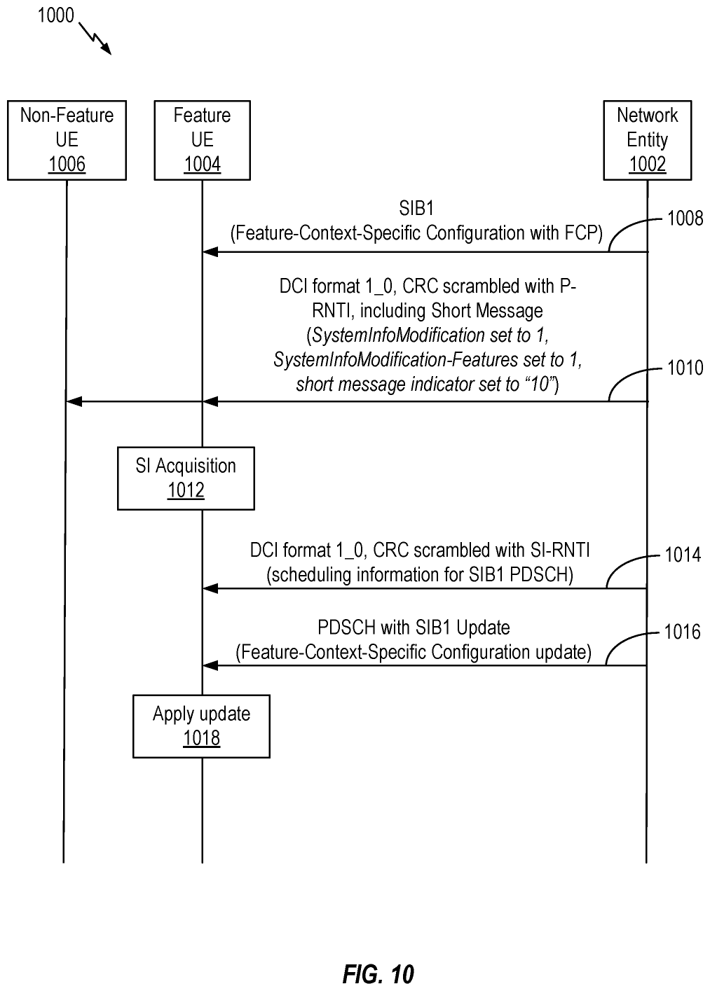

FIG. 10 depicts a process flow 1000 for communications in a network between a network entity 1002, a feature-UE 1004, and a non-feature-UE 1006 for context-specific configuration update. In some aspects, the network entity 1002 may be an example of the BS 102 depicted and described with respect to FIGS. 1 and 3 or a disaggregated base station depicted and described with respect to FIG. 2. Similarly, the feature UE 1004 and the non-feature-UE 1006 may be an example of UEs 104 depicted and described with respect to FIGS. 1 and 3. However, in other aspects, the feature-UE 1004 and/or UE 1006 may be another type of wireless communications device and network entity 1002 may be another type of network entity or network node, such as those described herein.

As shown, at operation 1008, network entity 1002 sends a SIB1 with a feature-context-specific configuration, which may include an FCP configuration (e.g., similar to operation 508 in the call flow 500). To update the feature-context-specific configuration, at operation 1010, the network entity 1002 sends a DCI format 1_0 with CRC scrambled with P-PRNTI that carries a short message with the SystemInfoModification field set indicating an update to system information (e.g., similar to operation 508 in the call flow 500) and carries a new short message field (e.g., systemInfoModification-Features) indicating the system information update is applicable only to feature-UEs and carries a new short message indicator (e.g., “10”) indicating the system information update is for feature configuration other than (or in addition to) FCP partition update, without feature filtering. As shown, the DCI is received by both the feature-UE 1004 and the non-feature-UE 1006. Because the short message indicates the feature-context-specific configuration update is applicable only to the feature-UEs, only the feature-UE 504 and initiates an SI acquisition procedure at operation 1012 (unlike operation 512 in call flow 500 in which the non-feature-UE 506 also initiates SI acquisition). At operation 1014, the network entity 1002 sends a DCI format 1_0 with CRC scrambled with SI-RNTI scheduling a PDSCH for SIB1 update. This DCI may be decoded only by the feature-UE 1004. At operation 1016, only the feature-UE 1004 may attempt to decode the PDSCH with the SIB1 carrying the updated feature-context-specific configuration. At operation 0118, the feature-UE 1004 applies the update.

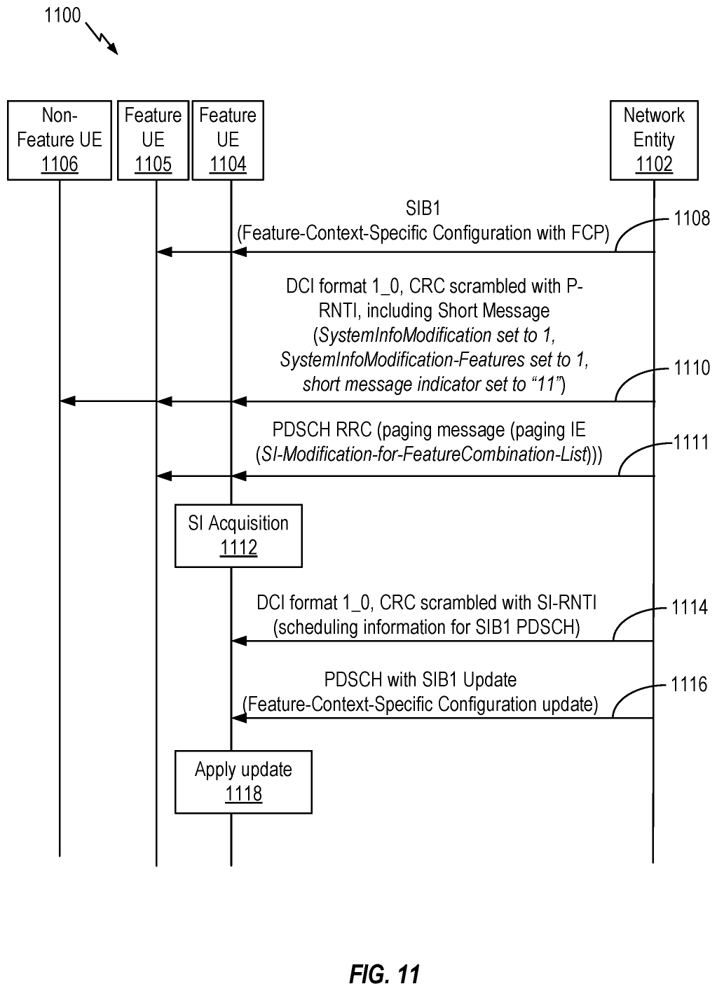

FIG. 11 depicts a process flow 1100 for communications in a network between a network entity 1102, a first feature-UE 1104, a second feature-UE 1105, and a non-feature-UE 1106 for context-specific configuration update with feature filtering. In some aspects, the network entity 1102 may be an example of the BS 102 depicted and described with respect to FIGS. 1 and 3 or a disaggregated base station depicted and described with respect to FIG. 2. Similarly, the feature UE 1104 and the non-feature-UE 1106 may be an example of UEs 104 depicted and described with respect to FIGS. 1 and 3. However, in other aspects, feature-UE 1104, feature-UE 1105, and/or non-feature-UE 1106 may be another type of wireless communications device and network entity 1102 may be another type of network entity or network node, such as those described herein.

As shown, at operation 1108, network entity 1102 sends a SIB1 with a feature-context-specific configuration, which may include an FCP configuration (e.g., similar to operation 508 in the call flow 500, and operation 1010 in the call flow 1000). To update the feature-context-specific configuration, at operation 1110, the network entity 1102 sends a DCI format 1_0 with CRC scrambled with P-PRNTI that carries a short message with the SystemInfoModification field set indicating an update to system information (e.g., similar to operation 508 in the call flow 500 and the operation 1008 in the call flow 1000) and carries a new short message field (e.g., systemInfoModification-Features) indicating the system information update is applicable only to feature-UEs (e.g., similar to operation 1008 in the call flow 1000) and carries a new short message indicator (e.g., “11”) indicating the system information update is for feature configuration other than (or in addition to) FCP partition update, with feature filtering. As shown, the DCI is received by both the first feature-UE 1104, the second feature-UE 1105, and the non-feature-UE 1106. Because the short message indicates the feature-context-specific configuration update is applicable only to features UEs, only the first feature-UE 1104 and the second feature-UE 1105 continue the procedure. In response to the short message indicator indicating feature filtering, the first feature-UE 1104 and the second feature-UE 1105 monitor a PDSCH to decode a paging RRC message with a paging IE containing the SI-Modification-for-FeatureCombination-List IE indicating one or more applicable features for the system information update. Feature-UE 1104 may support one or more features indicated in the SI-Modification-for-FeatureCombination-List IE, while feature-UE 1105 may support none of the features indicated in the SI-Modification-for-FeatureCombination-List IE. Thus, only the feature-UE 1104 initiates the SI acquisition procedure at operation 1112. At operation 1114, the network entity 1102 sends a DCI format 1_0 with CRC scrambled with SI-RNTI scheduling a PDSCH for SIB1 update. This DCI may be decoded only by the feature-UE 1104. At operation 1116, only the feature-UE 1104 may attempt to decode the PDSCH with the SIB1 carrying the updated feature-context-specific configuration. At operation 1118, the feature-UE 1104 applies the update.

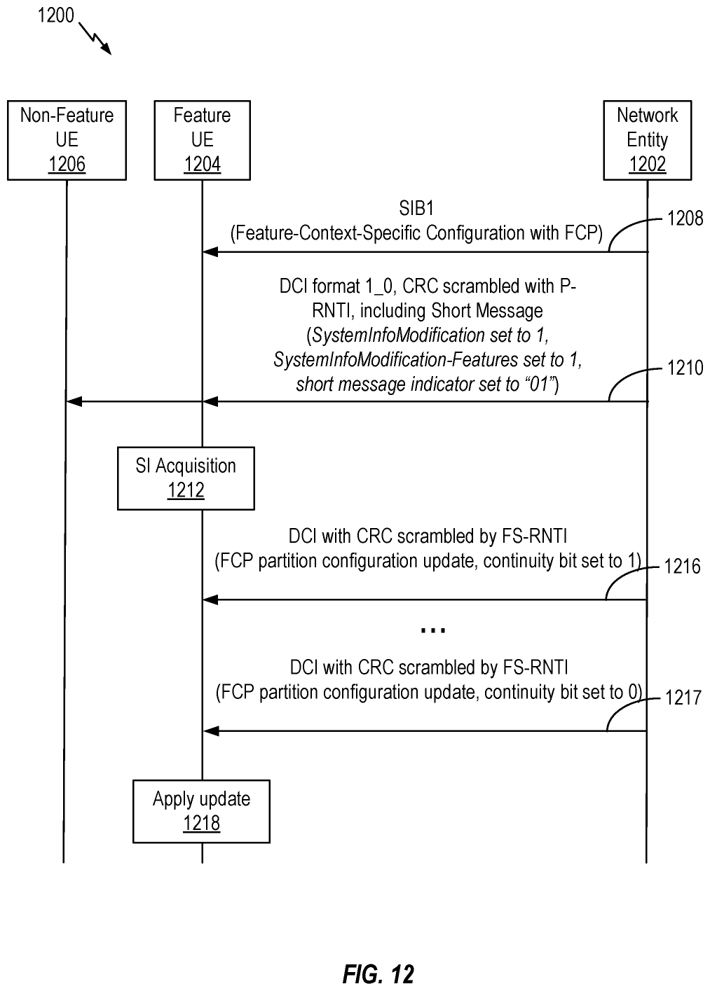

FIG. 12 depicts a process flow 1200 for communications in a network between a network entity 1202, a feature-UE 1204, and a non-feature-UE 1206 for FCP partition update. In some aspects, the network entity 1202 may be an example of the BS 102 depicted and described with respect to FIGS. 1 and 3 or a disaggregated base station depicted and described with respect to FIG. 2. Similarly, the feature UE 1204 and the non-feature-UE 1206 may be an example of UEs 104 depicted and described with respect to FIGS. 1 and 3. However, in other aspects, feature-UE 1204 and/or non-feature-UE 1206 may be another type of wireless communications device and network entity 1202 may be another type of network entity or network node, such as those described herein.

As shown, at operation 1208, network entity 1202 sends a SIB1 with a feature-context-specific configuration which includes an FCP partition configuration. To update the FCP partition configuration, at operation 1210, the network entity 1202 sends a DCI format 1_0 with CRC scrambled with P-PRNTI that carries a short message with the SystemInfoModification field set indicating an update to system information (e.g., similar to operation 508 in the call flow 500) and carries a new short message field (e.g., systemInfoModification-Features) indicating the system information update is applicable only to feature-UEs and carries a new short message indicator (e.g., “01”) indicating the system information update is only for FCP partition update. As shown, the DCI is received by both the feature-UE 1204 and the non-feature-UE 1206. Because the short message indicates the FCP partition update applicable only to the feature-UEs, only the feature-UE 504 and initiates an SI acquisition procedure at operation 1212 and monitors a new feature search space. At operation 1216, the network entity 1202 sends a DCI format 1_0 with CRC scrambled with FS-RNTI carrying the updated FCP partition configuration and with a continuity bit indicating additional DCI for FCP partition update. The feature-UE 1204 continues to monitor the feature search space until the feature-UE 1204 receives a DCI with CRC scrambled by FS-RNTI and with the continuity bit set to indicate no additional DCI for FCP partition update at operation 1217. At operation 1218, the feature-UE 1204 applies the update.

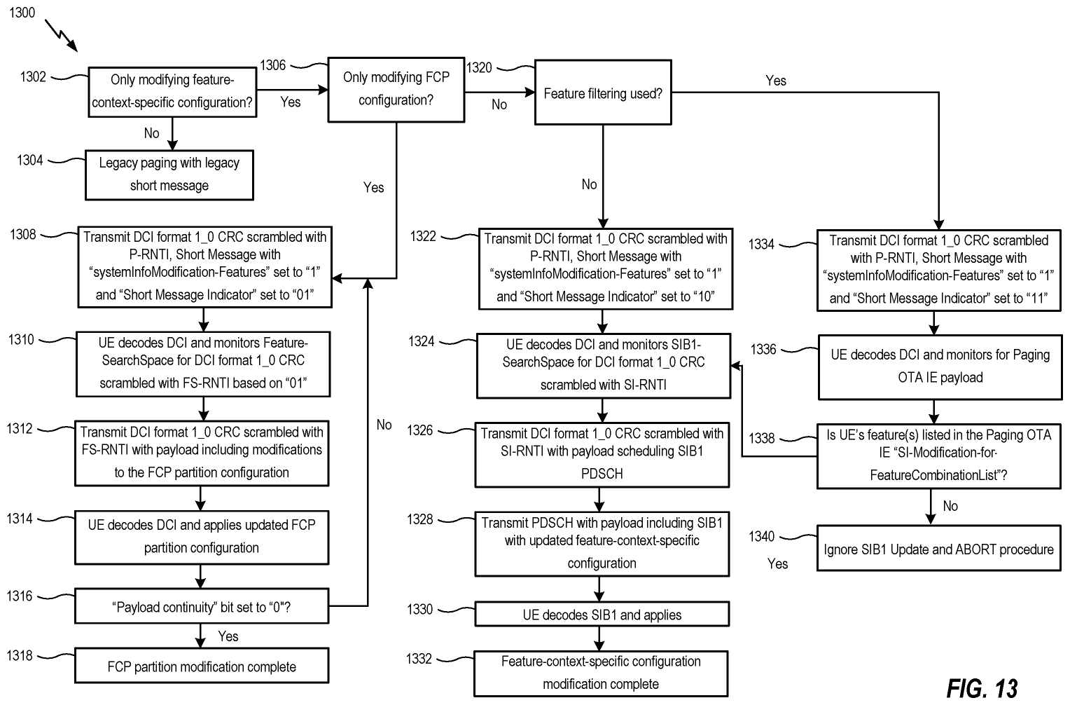

FIG. 13 is a diagram illustrating operations 1300 for FCP partition update, feature-context-specific configuration update without feature filtering, and feature-context-specific configuration update with feature filtering.

As shown, at operation 1302, the network may determine whether only the feature-context-specific configuration is being modified. At operation 1304, if no, then legacy paging and legacy short message may be used for system information update (e.g., because the system information is applicable non-feature-UEs).

At operation 1306, if yes, then the network may further determine whether only an FCP partition configuration is being modified. If yes, the system may continue to the operations 1308-1318 for FCP partition configuration update. If no, the system may continue to operation 1320 for other feature-context-specific modification.

For the FCP partition configuration update only, at operation 1308, the network transmits to all registered UEs the DCI format 1_0 with CRC scrambled by P-RNTI having the systemInfoModification bit set to 1, the systemInfoModification-Features bit set to 1, and the short message indicator field set to “01” to indicate FCP partition update only. At operation 1310, the UEs decode the DCI and the feature-UEs only monitor the Feature-SearchSpace for DCI format 1_0 scrambled with FS-RNTI. At operation 1312 the UE decodes the DCI format 1_0 scrambled with FS-RNTI carrying the FCP partition update configuration. At 1316, the network determines whether there are additional FCP partition updates and sets the continuity bit in the DCI format 1_0 scrambled with FS-RNTI to “1” if there or “0” if there are not. The operations return to operation 1308 if the continuity bit is set to “1” or proceeds to the operation 1318 if the continuity bit is set to “0.” At operation 1318, the FCP partition modification is complete.

At operation 1320, the network determines whether feature filtering is used. If yes, the system proceeds to the operation 1334 for feature-context-specific configuration update with feature filtering. If no, the system proceeds to the operation 1322 for feature-context-specific configuration update without feature filtering.

For the feature-context-specific configuration update without feature filtering, at operation 1322, the network transmits to all registered UEs the DCI format 1_0 with CRC scrambled by P-RNTI having the systemInfoModification bit set to 1, the systemInfoModification-Features bit set to 1, and the short message indicator field set to “10” to indicate feature-context-specific configuration update, other than FCP partition update, without feature filtering. At operation 1324, the UEs decode the DCI and only the feature-UEs initiate the system information acquisition procedure and monitor a SIB1-SearchSpace for DCI format 1_0 with CRC scrambled by SI-RNTI. At operation 1326, the network transmits, and feature-UEs decode, the DCI format 1_0 with CRC scrambled by SI-RNTI scheduling a PDSCH carrying the SIB1 update. At operation 1330, the network transmits and the feature-UEs decode the SIB1 update, and the feature-UEs apply the updated feature-context-specific configuration. At operation 1332, the feature-context-specific configuration modification is complete.

For the feature-context-specific configuration update with feature filtering, at operation 1334, the network transmits to all registered UEs the DCI format 1_0 with CRC scrambled by P-RNTI having the systemInfoModification bit set to 1, the systemInfoModification-Features bit set to 1, and the short message indicator field set to “11” to indicate feature-context-specific configuration update, other than FCP partition update, with feature filtering. At operation 1336, the network transmits and the feature-UEs only decode a PDSCH paging message with a paging IE containing the SI-Modification-for-FeatureCombination-List IE. At operation 1338, the feature-UEs determines whether the UE supports any features listed in the SI-Modification-for-FeatureCombination-List IE. If not, then at operation 1340 the UE aborts the system information acquisition procedure and ignores the system information update. If yes, then the system proceeds to the operations 1324-1332.

### Example Methods

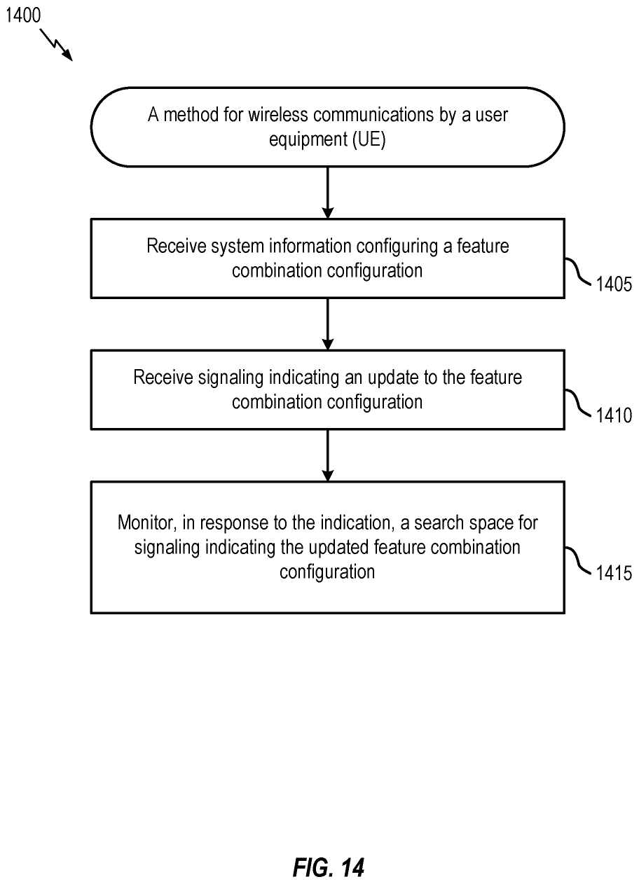

FIG. 14 shows an example of a method 1400 of wireless communications by a user equipment (UE), such as a UE 104 of FIGS. 1 and 3.

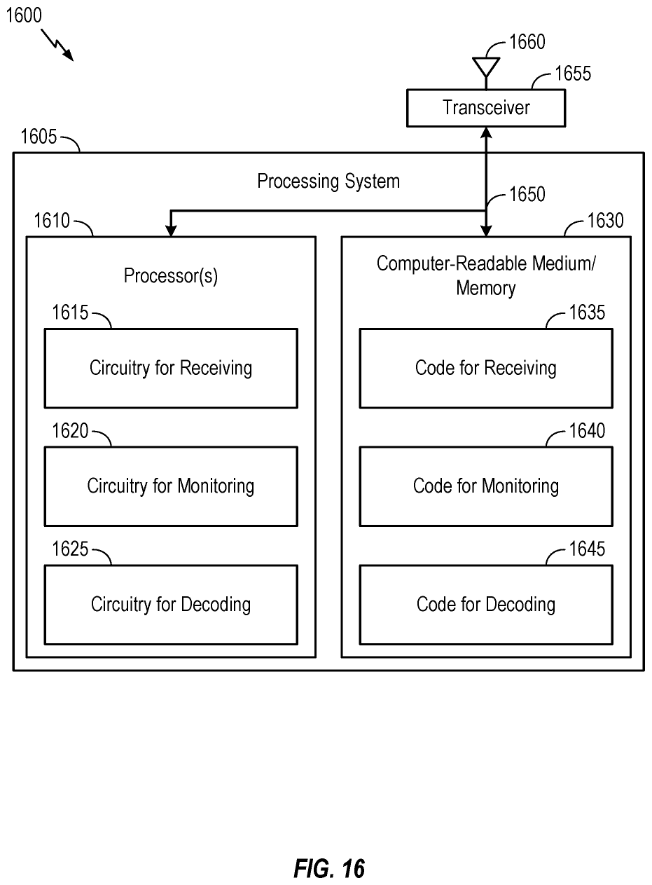

Method 1400 begins at step 1405 with receiving system information configuring a feature combination configuration. In some cases, the operations of this step refer to, or may be performed by, circuitry for receiving and/or code for receiving as described with reference to FIG. 16.

Method 1400 then proceeds to step 1410 with receiving signaling indicating an update to the feature combination configuration. In some cases, the operations of this step refer to, or may be performed by, circuitry for receiving and/or code for receiving as described with reference to FIG. 16.

Method 1400 then proceeds to step 1415 with monitoring, in response to the indication, a search space for signaling indicating the updated feature combination configuration. In some cases, the operations of this step refer to, or may be performed by, circuitry for monitoring and/or code for monitoring as described with reference to FIG. 16.

In some aspects, the system information configuring the feature combination configuration comprises an initial system information block (SIB) configuring one or more feature combinations for the UE.

In some aspects, the system information configuring the feature combination configuration comprises a radio resource control (RRC) feature combination information element (IE) specifying one or more features.

In some aspects, the one or more features comprise one or more of: reduced capability (RedCaP), enhanced RedCAP, small data transmission (SDT), a feature combination preamble (FCP) partition configuration, network slice as group (NSAG), or random access message 3 repetition.

In some aspects, the signaling indicating the update to the feature combination configuration comprises signaling indicating a system information update applicable only to UEs that support one or more feature combinations of the feature combination configuration, and wherein the monitoring the search space for the signaling indicating the updated feature combination in response to the indication comprises attempting to decode the signaling indicating the updated feature combination configuration based on the UE supporting one or more of the feature combinations.

In some aspects, the monitoring the search space for the signaling indicating the updated feature combination in response to the indication comprises refraining from attempting to decode the signaling indicating the updated feature combination configuration based on the UE not supporting the one or more of the feature combinations.

In some aspects, the signaling indicating the update to the feature combination configuration comprises a downlink control information (DCI) with a short message field indicating the update to the feature combination configuration.

In some aspects, the DCI comprises a DCI format 1_0 with a cyclic redundancy check (CRC) scrambled by a physical radio network temporary identifier (P-RNTI).

In some aspects, the indication of the update to the feature combination configuration is provided using a reserved bit of an existing DCI format 1_0 with the CRC scrambled by the P-RNTI.

In some aspects, the DCI further includes a short message indicator field, further comprising interpreting bit values of the short message indicator field based on the short message field indicating the update to the feature combination configuration.

In some aspects, the DCI further includes a short message indicator field indicating the feature combination configuration update with no feature filtering.

In some aspects, the DCI further includes a short message indicator field indicating to monitor a system information block (SIB) search space to attempt to decode the signaling indicating the updated feature combination.

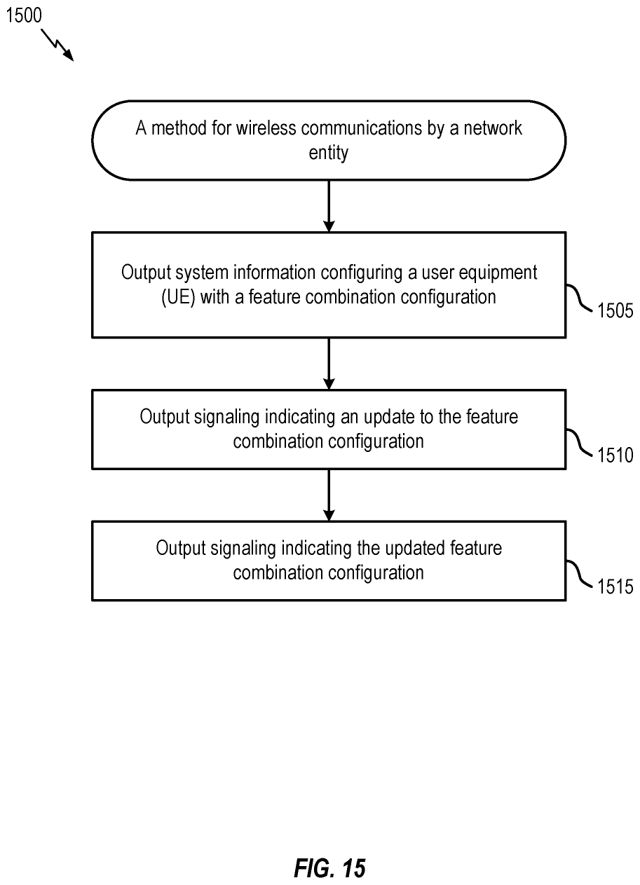

In some aspects, the method 1400 further includes receiving a DCI in the SIB search space, wherein the DCI schedules a physical downlink shared channel (PDSCH) transmission. In some cases, the operations of this step refer to, or may be performed by, circuitry for receiving and/or code for receiving as described with reference to FIG. 15.

In some aspects, the method 1400 further includes decoding the PDSCH transmission, wherein the PDSCH transmission includes a payload carrying updated system information comprising the feature combination configuration update. In some cases, the operations of this step refer to, or may be performed by, circuitry for decoding and/or code for decoding as described with reference to FIG. 16.

In some aspects, the signaling indicating the updated feature combination comprises a DCI format 1_0 with a cyclic redundancy check (CRC) scrambled by a system information radio network temporary identifier (SI-RNTI).

In some aspects, the DCI further includes a short message indicator field indicating the feature combination configuration update with feature filtering.

In some aspects, the DCI further includes a short message indicator field indicating to monitor for a paging information element (IE), further comprising receiving the paging IE, wherein the paging IE indicates one or more features associated with the feature combination configuration update.

In some aspects, the receiving the paging IE comprises: monitoring for a paging physical downlink shared channel (PDSCH) transmission; and decoding the paging PDSCH transmission, wherein: a payload of the paging PDSCH transmission comprises a radio resource control (RRC) paging message; the RRC paging message comprises a paging IE; and a system information modification for feature combinations list IE in the paging IE indicates the one or more feature associated with the feature combination configuration update.

In some aspects, the monitoring the search space for the signaling indicating the updated feature combination configuration in response to the indication is further in response to determining that at least one of the one or more features in the paging IE is supported by the UE.

In some aspects, the monitoring the search space for the signaling indicating the updated feature combination configuration in response to the indication comprises refraining from attempting to decode the signaling indicating the updated feature combination configuration in response to determining that none of the one or more features in the paging IE is supported by the UE.

In some aspects, the DCI further includes a short message indicator field indicating the feature combination configuration update is for a feature combination preamble (FCP) partition configuration update.

In some aspects, the DCI further includes a short message indicator field indicating to monitor a feature combination search space for a DCI indicating the updated feature combination.

In some aspects, the method 1400 further includes receiving signaling preconfiguring the feature combination search space. In some cases, the operations of this step refer to, or may be performed by, circuitry for receiving and/or code for receiving as described with reference to FIG. 16.

In some aspects, the signaling indicating the FCP partition configuration update comprises a DCI with a cyclic redundancy check (CRC) scrambled by feature specific radio network temporary identifier (FS-RNTI).

In some aspects, the DCI with the CRC scrambled by the FS-RNTI includes a purpose indicator field indicating the DCI is for FCP partition configuration update.

In some aspects, the DCI with the CRC scrambled by the FS-RNTI includes one or more fields indicating the FCP partition configuration update for an FCP partition.

In some aspects, the DCI with the CRC scrambled by the FS-RNTI includes a continuity bit indicating one or more additional DCIs with FCP partition configuration updates for one or more additional FCP partitions.

In some aspects, the method 1400 further includes monitoring the feature combination search space for the one or more additional DCIs until a DCI is received with a continuity bit indicating no additional DCIs with FCP partition configuration updates. In some cases, the operations of this step refer to, or may be performed by, circuitry for monitoring and/or code for monitoring as described with reference to FIG. 15.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

FIG. 15 shows an example of a method 1500 of wireless communications by a network entity, such as a BS 102 of FIGS. 1 and 3, or a disaggregated base station as discussed with respect to FIG. 2.

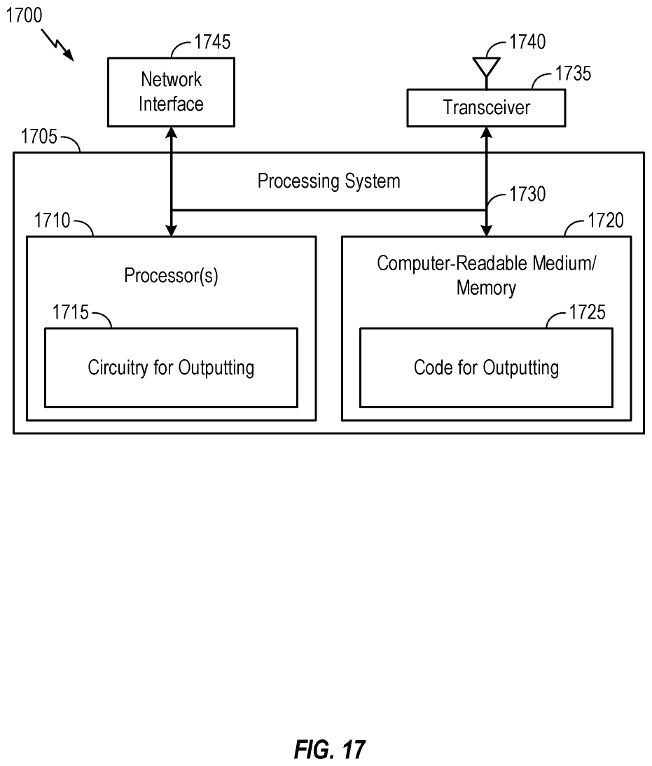

Method 1500 begins at step 1505 with outputting system information configuring a user equipment (UE) with a feature combination configuration. In some cases, the operations of this step refer to, or may be performed by, circuitry for outputting and/or code for outputting as described with reference to FIG. 17.

Method 1500 then proceeds to step 1510 with outputting signaling indicating an update to the feature combination configuration. In some cases, the operations of this step refer to, or may be performed by, circuitry for outputting and/or code for outputting as described with reference to FIG. 17.

Method 1500 then proceeds to step 1515 with outputting signaling indicating the updated feature combination configuration. In some cases, the operations of this step refer to, or may be performed by, circuitry for outputting and/or code for outputting as described with reference to FIG. 17.

In some aspects, the system information configuring the feature combination configuration comprises an initial system information block (SIB) configuring one or more feature combinations for the UE.

In some aspects, the system information configuring the feature combination configuration comprises a radio resource control (RRC) feature combination information element (IE) specifying one or more features.

In some aspects, the one or more features comprise one or more of: reduced capability (RedCaP), enhanced RedCAP, small data transmission (SDT), a feature combination preamble (FCP) partition configuration, network slice as group (NSAG), or random access message 3 repetition.

In some aspects, the signaling indicating the update to the feature combination configuration comprises signaling indicating a system information update applicable only to UEs that support one or more feature combinations of the feature combination configuration.

In some aspects, the signaling indicating the update to the feature combination configuration comprises signaling indicating for only UEs that support the one or more feature combinations to monitor a search space for the signaling indicating the updated feature combination.

In some aspects, the signaling indicating the update to the feature combination configuration comprises a downlink control information (DCI) with a short message field indicating the update to the feature combination configuration.

In some aspects, the DCI comprises a DCI format 1_0 with a cyclic redundancy check (CRC) scrambled by a physical radio network temporary identifier (P-RNTI).

In some aspects, the indication of the update to the feature combination configuration is provided using a reserved bit of an existing DCI format 1_0 with the CRC scrambled by the P-RNTI.

In some aspects, the DCI further includes a short message indicator field indicating the feature combination configuration update with no feature filtering.

In some aspects, the DCI further includes a short message indicator field indicating to monitor a system information block (SIB) search space to attempt to decode the signaling indicating the updated feature combination.

In some aspects, the method 1500 further includes outputting a DCI in the SIB search space, wherein the DCI schedules a physical downlink shared channel (PDSCH) transmission. In some cases, the operations of this step refer to, or may be performed by, circuitry for outputting and/or code for outputting as described with reference to FIG. 17.

In some aspects, the method 1500 further includes outputting the PDSCH transmission, wherein the PDSCH transmission includes a payload carrying updated system information comprising the feature combination configuration update. In some cases, the operations of this step refer to, or may be performed by, circuitry for outputting and/or code for outputting as described with reference to FIG. 17.

In some aspects, the signaling indicating the updated feature combination comprises a DCI format 1_0 with a cyclic redundancy check (CRC) scrambled by a system information radio network temporary identifier (SI-RNTI).

In some aspects, the DCI further includes a short message indicator field indicating the feature combination configuration update with feature filtering.

In some aspects, the DCI further includes a short message indicator field indicating to monitor for a paging information element (IE), further comprising outputting the paging IE, wherein the paging IE indicates one or more features associated with the feature combination configuration update.

In some aspects, the outputting the paging IE comprises outputting a paging physical downlink shared channel (PDSCH) transmission, wherein: a payload of the paging PDSCH transmission comprises a radio resource control (RRC) paging message; the RRC paging message comprises a paging IE; and a system information modification for feature combinations list IE in the paging IE indicates the one or more feature associated with the feature combination configuration update.

In some aspects, the short message indicator field indicates only UEs that support at least one of the one or more features in the paging IE to monitor the signaling indicating the updated feature combination configuration.

In some aspects, the short message indicator field indicates UEs that support none of the one or more features in the paging IE to refrain from monitoring the signaling indicating the updated feature combination configuration.

In some aspects, the DCI further includes a short message indicator field indicating the feature combination configuration update is for a feature combination preamble (FCP) partition configuration update.

In some aspects, the DCI further includes a short message indicator field indicating to monitor a feature combination search space for a DCI indicating the updated feature combination.

In some aspects, the method 1500 further includes outputting signaling preconfiguring the feature combination search space. In some cases, the operations of this step refer to, or may be performed by, circuitry for outputting and/or code for outputting as described with reference to FIG. 17.

In some aspects, the signaling indicating the FCP partition configuration update comprises a DCI with a cyclic redundancy check (CRC) scrambled by feature specific radio network temporary identifier (FS-RNTI).

In some aspects, the DCI with the CRC scrambled by the FS-RNTI includes a purpose indicator field indicating the DCI is for FCP partition configuration update.

In some aspects, the DCI with the CRC scrambled by the FS-RNTI includes one or more fields indicating the FCP partition configuration update for an FCP partition.

In some aspects, the DCI with the CRC scrambled by the FS-RNTI includes a continuity bit indicating one or more additional DCIs with FCP partition configuration updates for one or more additional FCP partitions.

In some aspects, the method 1500 further includes outputting, in the feature combination search space, one or more additional DCIs, wherein a last DCI of the one or more additional DCIs includes a continuity bit indicating no additional DCIs with FCP partition configuration updates. In some cases, the operations of this step refer to, or may be performed by, circuitry for outputting and/or code for outputting as described with reference to FIG. 17.

In one aspect, method 1500, or any aspect related to it, may be performed by an apparatus, such as communications device 1700 of FIG. 17, which includes various components operable, configured, or adapted to perform the method 1500. Communications device 1600 is described below in further detail.

Note that FIG. 15 is just one example of a method, and other methods including fewer, additional, or alternative steps are possible consistent with this disclosure.

### Example Communications Device(s)

FIG. 16 depicts aspects of an example communications device 1600. In some aspects, communications device 1600 is a user equipment, such as UE 104 described above with respect to FIGS. 1 and 3.

The communications device 1600 includes a processing system 1605 coupled to the transceiver 1655 (e.g., a transmitter and/or a receiver). The transceiver 1655 is configured to transmit and receive signals for the communications device 1600 via the antenna 1660, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. The one or more processors 1610 are coupled to a computer-readable medium/memory 1630 via a bus 1650. In certain aspects, the computer-readable medium/memory 1630 is configured to store instructions (e.g., computer-executable code) that when executed by the one or more processors 1610, cause the one or more processors 1610 to perform the method 1400 described with respect to FIG. 14, or any aspect related to it. Note that reference to a processor performing a function of communications device 1600 may include one or more processors 1610 performing that function of communications device 1600.

In the depicted example, computer-readable medium/memory 1630 stores code (e.g., executable instructions), such as code for receiving 1635, code for monitoring 1640, and code for decoding 1645. Processing of the code for receiving 1635, code for monitoring 1640, and code for decoding 1645 may cause the communications device 1600 to perform the method 1400 described with respect to FIG. 14, or any aspect related to it.

The one or more processors 1610 include circuitry configured to implement (e.g., execute) the code stored in the computer-readable medium/memory 1630, including circuitry such as circuitry for receiving 1616, circuitry for monitoring 1620, and circuitry for decoding 1625. Processing with circuitry for receiving 1616, circuitry for monitoring 1620, and circuitry for decoding 1625 may cause the communications device 1600 to perform the method 1400 described with respect to FIG. 14, or any aspect related to it.

Various components of the communications device 1600 may provide means for performing the method 1400 described with respect to FIG. 14, or any aspect related to it. For example, means for transmitting, sending or outputting for transmission may include transceivers 354 and/or antenna(s) 352 of the UE 104 illustrated in FIG. 3 and/or the transceiver 1655 and the antenna 1660 of the communications device 1600 in FIG. 16. Means for receiving or obtaining may include transceivers 354 and/or antenna(s) 352 of the UE 104 illustrated in FIG. 3 and/or the transceiver 1655 and the antenna 1660 of the communications device 1600 in FIG. 16.

FIG. 17 depicts aspects of an example communications device 1700. In some aspects, communications device 1700 is a network entity, such as BS 102 of FIGS. 1 and 3, or a disaggregated base station as discussed with respect to FIG. 2.

The communications device 1700 includes a processing system 1705 coupled to the transceiver 1735 (e.g., a transmitter and/or a receiver) and/or a network interface 1745. The transceiver 1735 is configured to transmit and receive signals for the communications device 1700 via the antenna 1740, such as the various signals as described herein. The network interface 1745 is configured to obtain and send signals for the communications device 1700 via communication link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1720 via a bus 1730. In certain aspects, the computer-readable medium/memory 1720 is configured to store instructions (e.g., computer-executable code) that when executed by the one or more processors 1710, cause the one or more processors 1710 to perform the method 1500 described with respect to FIG. 15, or any aspect related to it. Note that reference to a processor of communications device 1700 performing a function may include one or more processors 1710 of communications device 1700 performing that function.

In the depicted example, the computer-readable medium/memory 1720 stores code (e.g., executable instructions), such as code for outputting 1725. Processing of the code for outputting 1725 may cause the communications device 1700 to perform the method 1500 described with respect to FIG. 15, or any aspect related to it.

The one or more processors 1710 include circuitry configured to implement (e.g., execute) the code stored in the computer-readable medium/memory 1720, including circuitry such as circuitry for outputting 1715. Processing with circuitry for outputting 1715 may cause the communications device 1700 to perform the method 1500 described with respect to FIG. 15, or any aspect related to it.

Various components of the communications device 1700 may provide means for performing the method 1500 described with respect to FIG. 15, or any aspect related to it. Means for transmitting, sending or outputting for transmission may include transceivers 332 and/or antenna(s) 334 of the BS 102 illustrated in FIG. 3 and/or the transceiver 1735 and the antenna 1740 of the communications device 1700 in FIG. 17. Means for receiving or obtaining may include transceivers 332 and/or antenna(s) 334 of the BS 102 illustrated in FIG. 3 and/or the transceiver 1735 and the antenna 1740 of the communications device 1700 in FIG. 17.

### Example Clauses

Implementation examples are described in the following numbered clauses:
Clause 1: A method for wireless communications by a user equipment (UE), comprising: receiving system information configuring a feature combination configuration; receiving signaling indicating an update to the feature combination configuration; and monitoring, in response to the indication, a search space for signaling indicating the updated feature combination configuration.
Clause 2: The method of Clause 1, wherein the system information configuring the feature combination configuration comprises an initial system information block (SIB) configuring one or more feature combinations for the UE.
Clause 3: The method of any combination of Clauses 1-2, wherein the system information configuring the feature combination configuration comprises a radio resource control (RRC) feature combination information element (IE) specifying one or more features.
Clause 4: The method of Clause 3, wherein the one or more features comprise one or more of: reduced capability (RedCaP), enhanced RedCAP, small data transmission (SDT), a feature combination preamble (FCP) partition configuration, network slice as group (NSAG), or random access message 3 repetition.
Clause 5: The method of any combination of Clauses 1-4, wherein the signaling indicating the update to the feature combination configuration comprises signaling indicating a system information update applicable only to UEs that support one or more feature combinations of the feature combination configuration, and wherein the monitoring the search space for the signaling indicating the updated feature combination in response to the indication comprises attempting to decode the signaling indicating the updated feature combination configuration based on the UE supporting one or more of the feature combinations.
Clause 6: The method of Clause 5, wherein the monitoring the search space for the signaling indicating the updated feature combination in response to the indication comprises refraining from attempting to decode the signaling indicating the updated feature combination configuration based on the UE not supporting the one or more of the feature combinations.
Clause 7: The method of any combination of Clauses 1-6, wherein the signaling indicating the update to the feature combination configuration comprises a downlink control information (DCI) with a short message field indicating the update to the feature combination configuration.
Clause 8: The method of Clause 7, wherein the DCI comprises a DCI format 1_0 with a cyclic redundancy check (CRC) scrambled by a physical radio network temporary identifier (P-RNTI).
Clause 9: The method of Clause 8, wherein the indication of the update to the feature combination configuration is provided using a reserved bit of an existing DCI format 1_0 with the CRC scrambled by the P-RNTI.
Clause 10: The method of any combination of Clauses 7-9, wherein the DCI further includes a short message indicator field, further comprising interpreting bit values of the short message indicator field based on the short message field indicating the update to the feature combination configuration.
Clause 11: The method of any combination of Clauses 7-10, wherein the DCI further includes a short message indicator field indicating the feature combination configuration update with no feature filtering.
Clause 12: The method of any combination of Clauses 7-11, wherein the DCI further includes a short message indicator field indicating to monitor a system information block (SIB) search space to attempt to decode the signaling indicating the updated feature combination.
Clause 13: The method of Clause 12, further comprising: receiving a DCI in the SIB search space, wherein the DCI schedules a physical downlink shared channel (PDSCH) transmission; and decoding the PDSCH transmission, wherein the PDSCH transmission includes a payload carrying updated system information comprising the feature combination configuration update.
Clause 14: The method of any combination of Clauses 7-13, wherein the signaling indicating the updated feature combination comprises a DCI format 1_0 with a cyclic redundancy check (CRC) scrambled by a system information radio network temporary identifier (SI-RNTI).
Clause 15: The method of any combination of Clauses 7-14, wherein the DCI further includes a short message indicator field indicating the feature combination configuration update with feature filtering.
Clause 16: The method of any combination of Clauses 7-14, wherein the DCI further includes a short message indicator field indicating to monitor for a paging information element (IE), further comprising receiving the paging IE, wherein the paging IE indicates one or more features associated with the feature combination configuration update.
Clause 17: The method of Clause 16, wherein the receiving the paging IE comprises: monitoring for a paging physical downlink shared channel (PDSCH) transmission; and decoding the paging PDSCH transmission, wherein: a payload of the paging PDSCH transmission comprises a radio resource control (RRC) paging message; the RRC paging message comprises a paging IE; and a system information modification for feature combinations list IE in the paging IE indicates the one or more feature associated with the feature combination configuration update.
Clause 18: The method of any combination of Clause 17, wherein the monitoring the search space for the signaling indicating the updated feature combination configuration in response to the indication is further in response to determining that at least one of the one or more features in the paging IE is supported by the UE.
Clause 19: The method of any combination of Clauses 17-18, wherein the monitoring the search space for the signaling indicating the updated feature combination configuration in response to the indication comprises refraining from attempting to decode the signaling indicating the updated feature combination configuration in response to determining that none of the one or more features in the paging IE is supported by the UE.
Clause 20: The method of any combination of Clauses 7-19, wherein the DCI further includes a short message indicator field indicating the feature combination configuration update is for a feature combination preamble (FCP) partition configuration update.
Clause 21: The method of Clause 20, wherein the DCI further includes a short message indicator field indicating to monitor a feature combination search space for a DCI indicating the updated feature combination.
Clause 22: The method of Clause 21, further comprising receiving signaling preconfiguring the feature combination search space.
Clause 23: The method of any combination of Clauses 21-22, wherein the signaling indicating the FCP partition configuration update comprises a DCI with a cyclic redundancy check (CRC) scrambled by feature specific radio network temporary identifier (FS-RNTI).
Clause 24: The method of Clause 23, wherein the DCI with the CRC scrambled by the FS-RNTI includes a purpose indicator field indicating the DCI is for FCP partition configuration update.
Clause 25: The method of any combination of Clauses 23-24, wherein the DCI with the CRC scrambled by the FS-RNTI includes one or more fields indicating the FCP partition configuration update for an FCP partition.
Clause 26: The method of Clause 25, wherein the DCI with the CRC scrambled by the FS-RNTI includes a continuity bit indicating one or more additional DCIs with FCP partition configuration updates for one or more additional FCP partitions.
Clause 27: The method of Clause 26, further comprising monitoring the feature combination search space for the one or more additional DCIs until a DCI is received with a continuity bit indicating no additional DCIs with FCP partition configuration updates.
Clause 28: A method for wireless communications by a network entity, comprising: outputting system information configuring a user equipment (UE) with a feature combination configuration; outputting signaling indicating an update to the feature combination configuration; and outputting signaling indicating the updated feature combination configuration.
Clause 29: The method of Clause 28, wherein the system information configuring the feature combination configuration comprises an initial system information block (SIB) configuring one or more feature combinations for the UE.
Clause 30: The method of any combination of Clauses 28-29, wherein the system information configuring the feature combination configuration comprises a radio resource control (RRC) feature combination information element (IE) specifying one or more features.
Clause 31: The method of Clause 30, wherein the one or more features comprise one or more of: reduced capability (RedCaP), enhanced RedCAP, small data transmission (SDT), a feature combination preamble (FCP) partition configuration, network slice as group (NSAG), or random access message 3 repetition.
Clause 32: The method of any combination of Clauses 28-31, wherein the signaling indicating the update to the feature combination configuration comprises signaling indicating a system information update applicable only to UEs that support one or more feature combinations of the feature combination configuration.
Clause 33: The method of Clause 32, wherein the signaling indicating the update to the feature combination configuration comprises signaling indicating for only UEs that support the one or more feature combinations to monitor a search space for the signaling indicating the updated feature combination.
Clause 34: The method of any combination of Clauses 28-33, wherein the signaling indicating the update to the feature combination configuration comprises a downlink control information (DCI) with a short message field indicating the update to the feature combination configuration.
Clause 35: The method of Clause 34, wherein the DCI comprises a DCI format 1_0 with a cyclic redundancy check (CRC) scrambled by a physical radio network temporary identifier (P-RNTI).
Clause 36: The method of Clause 35, wherein the indication of the update to the feature combination configuration is provided using a reserved bit of an existing DCI format 1_0 with the CRC scrambled by the P-RNTI.
Clause 37: The method of any combination of Clauses 34-36, wherein the DCI further includes a short message indicator field indicating the feature combination configuration update with no feature filtering.
Clause 38: The method of any combination of Clauses 34-37, wherein the DCI further includes a short message indicator field indicating to monitor a system information block (SIB) search space to attempt to decode the signaling indicating the updated feature combination.
Clause 39: The method of Clause 38, further comprising: outputting a DCI in the SIB search space, wherein the DCI schedules a physical downlink shared channel (PDSCH) transmission; and outputting the PDSCH transmission, wherein the PDSCH transmission includes a payload carrying updated system information comprising the feature combination configuration update.
Clause 40: The method of any combination of Clauses 34-39, wherein the signaling indicating the updated feature combination comprises a DCI format 1_0 with a cyclic redundancy check (CRC) scrambled by a system information radio network temporary identifier (SI-RNTI).
Clause 41: The method of any combination of Clauses 34-40, wherein the DCI further includes a short message indicator field indicating the feature combination configuration update with feature filtering.
Clause 42: The method of any combination of Clauses 34-41, wherein the DCI further includes a short message indicator field indicating to monitor for a paging information element (IE), further comprising outputting the paging IE, wherein the paging IE indicates one or more features associated with the feature combination configuration update.
Clause 43: The method of Clause 42, wherein the outputting the paging IE comprises outputting a paging physical downlink shared channel (PDSCH) transmission, wherein: a payload of the paging PDSCH transmission comprises a radio resource control (RRC) paging message; the RRC paging message comprises a paging IE; and a system information modification for feature combinations list IE in the paging IE indicates the one or more feature associated with the feature combination configuration update.
Clause 44: The method of any combination of Clauses 42-43, wherein the short message indicator field indicates only UEs that support at least one of the one or more features in the paging IE to monitor the signaling indicating the updated feature combination configuration.
Clause 45: The method of any combination of Clauses 42-44, wherein the short message indicator field indicates UEs that support none of the one or more features in the paging IE to refrain from monitoring the signaling indicating the updated feature combination configuration.
Clause 46: The method of any combination of Clauses 34-45, wherein the DCI further includes a short message indicator field indicating the feature combination configuration update is for a feature combination preamble (FCP) partition configuration update.
Clause 47: The method of Clause 46, wherein the DCI further includes a short message indicator field indicating to monitor a feature combination search space for a DCI indicating the updated feature combination.
Clause 48: The method of Clause 47, further comprising outputting signaling preconfiguring the feature combination search space.
Clause 49: The method of any combination of Clauses 47-48, wherein the signaling indicating the FCP partition configuration update comprises a DCI with a cyclic redundancy check (CRC) scrambled by feature specific radio network temporary identifier (FS-RNTI).
Clause 50: The method of Clause 49, wherein the DCI with the CRC scrambled by the FS-RNTI includes a purpose indicator field indicating the DCI is for FCP partition configuration update.
Clause 51: The method of any combination of Clauses 49-50, wherein the DCI with the CRC scrambled by the FS-RNTI includes one or more fields indicating the FCP partition configuration update for an FCP partition.
Clause 52: The method of Clause 51, wherein the DCI with the CRC scrambled by the FS-RNTI includes a continuity bit indicating one or more additional DCIs with FCP partition configuration updates for one or more additional FCP partitions.
Clause 53: The method of Clause 52, further comprising outputting, in the feature combination search space, one or more additional DCIs, wherein a last DCI of the one or more additional DCIs includes a continuity bit indicating no additional DCIs with FCP partition configuration updates.
Clause 54: An apparatus, comprising: at least one memory comprising executable instructions; and at least one processor configured to execute the executable instructions and cause the apparatus to perform a method in accordance with any combination of Clauses 1-53.
Clause 55: An apparatus, comprising means for performing a method in accordance with any combination of Clauses 1-53.
Clause 56: A non-transitory computer-readable medium comprising executable instructions that, when executed by at least one processor of an apparatus, cause the apparatus to perform a method in accordance with any combination of Clauses 1-53.
Clause 57: A computer program product embodied on a computer-readable storage medium comprising code for performing a method in accordance with any combination of Clauses 1-53.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

Means for receiving, means for monitoring, means for decoding, and means for outputting may comprise one or more processors, such as one or more of the processors described above with reference to FIG. 15, and FIG. 16.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, the apparatus comprising:
at least one memory comprising computer-executable instructions; and
one or more processors configured to execute the computer-executable instructions and cause the apparatus to:
receive system information configuring a feature combination configuration;
receive signaling indicating an update to the feature combination configuration; and
monitor, in response to the indication, a search space for signaling indicating the updated feature combination configuration.

2. The apparatus of claim 1, wherein the system information configuring the feature combination configuration comprises an initial system information block (SIB) configuring one or more feature combinations for the apparatus.

3. The apparatus of claim 1, wherein the system information configuring the feature combination configuration comprises a radio resource control (RRC) feature combination information element (IE) specifying one or more features.

4. The apparatus of claim 3, wherein the one or more features comprise one or more of: reduced capability (RedCaP), enhanced RedCAP, small data transmission (SDT), a feature combination preamble (FCP) partition configuration, network slice as group (NSAG), or random access message 3 repetition.

5. The apparatus of claim 1, wherein the signaling indicating the update to the feature combination configuration comprises signaling indicating a system information update applicable only to apparatuses that support one or more feature combinations of the feature combination configuration, and wherein the one or more processors are configured to cause the apparatus to attempt to decode the signaling indicating the updated feature combination configuration based on the apparatus supporting one or more of the feature combinations.

6. The apparatus of claim 5, wherein the one or more processors are configured to cause the apparatus to refrain from attempting to decode the signaling indicating the updated feature combination configuration based on the apparatus not supporting the one or more of the feature combinations.

7. The apparatus of claim 1, wherein the signaling indicating the update to the feature combination configuration comprises a downlink control information (DCI) with a short message field indicating the update to the feature combination configuration.

8. The apparatus of claim 7, wherein the DCI comprises a DCI format 1_0 with a cyclic redundancy check (CRC) scrambled by a physical radio network temporary identifier (P-RNTI).

9. The apparatus of claim 8, wherein the indication of the update to the feature combination configuration is provided using a reserved bit of an existing DCI format 1_0 with the CRC scrambled by the P-RNTI.

10. The apparatus of claim 7, wherein the DCI further includes a short message indicator field, further comprising interpreting bit values of the short message indicator field based on the short message field indicating the update to the feature combination configuration.

11. The apparatus of claim 7, wherein the DCI further includes a short message indicator field indicating the feature combination configuration update with no feature filtering.

12. The apparatus of claim 7, wherein the DCI further includes a short message indicator field indicating to monitor a system information block (SIB) search space to attempt to decode the signaling indicating the updated feature combination.

13. The apparatus of claim 12, wherein the one or more processors are further configured to cause the apparatus to:
receive a DCI in the SIB search space, wherein the DCI schedules a physical downlink shared channel (PDSCH) transmission; and
decode the PDSCH transmission, wherein the PDSCH transmission includes a payload carrying updated system information comprising the feature combination configuration update.

14. The apparatus of claim 7, wherein the signaling indicating the updated feature combination comprises a DCI format 1_0 with a cyclic redundancy check (CRC) scrambled by a system information radio network temporary identifier (SI-RNTI).

15. The apparatus of claim 7, wherein the DCI further includes a short message indicator field indicating the feature combination configuration update with feature filtering.

16. The apparatus of claim 7, wherein the DCI further includes a short message indicator field indicating to monitor for a paging information element (IE), further comprising receiving the paging IE, wherein the paging IE indicates one or more features associated with the feature combination configuration update.

17. The apparatus of claim 16, wherein the one or more processors are configured to cause the apparatus to:
monitor for a paging physical downlink shared channel (PDSCH) transmission; and
decode the paging PDSCH transmission, wherein:
a payload of the paging PDSCH transmission comprises a radio resource control (RRC) paging message;
the RRC paging message comprises a paging IE; and
a system information modification for feature combinations list IE in the paging IE indicates the one or more feature associated with the feature combination configuration update.

18. The apparatus of claim 17, wherein the one or more processors are configured to cause the apparatus to monitor the search space for the signaling indicating the updated feature combination configuration further in response to determining that at least one of the one or more features in the paging IE is supported by the apparatus.

19. The apparatus of claim 17, wherein the one or more processors are configured to cause the apparatus to refrain from attempting to decode the signaling indicating the updated feature combination configuration in response to determining that none of the one or more features in the paging IE is supported by the apparatus.

20. The apparatus of claim 7, wherein the DCI further includes a short message indicator field indicating the feature combination configuration update is for a feature combination preamble (FCP) partition configuration update.

21. The apparatus of claim 20, wherein the DCI further includes a short message indicator field indicating to monitor a feature combination search space for a DCI indicating the updated feature combination.

22. The apparatus of claim 21, wherein the one or more processors are further configured to cause the apparatus to receive signaling preconfiguring the feature combination search space.

23. The apparatus of claim 21, wherein the signaling indicating the FCP partition configuration update comprises a DCI with a cyclic redundancy check (CRC) scrambled by feature specific radio network temporary identifier (FS-RNTI).

24. The apparatus of claim 23, wherein the DCI with the CRC scrambled by the FS-RNTI includes a purpose indicator field indicating the DCI is for FCP partition configuration update.

25. The apparatus of claim 23, wherein the DCI with the CRC scrambled by the FS-RNTI includes one or more fields indicating the FCP partition configuration update for an FCP partition.

26. The apparatus of claim 25, wherein the DCI with the CRC scrambled by the FS-RNTI includes a continuity bit indicating one or more additional DCIs with FCP partition configuration updates for one or more additional FCP partitions.

27. The apparatus of claim 26, wherein the one or more processors are further configured to cause the apparatus to monitor the feature combination search space for the one or more additional DCIs until a DCI is received with a continuity bit indicating no additional DCIs with FCP partition configuration updates.

28. An apparatus for wireless communication, comprising:
at least one memory comprising computer-executable instructions; and
one or more processors configured to execute the computer-executable instructions and cause the apparatus to:
output system information configuring a user equipment (UE) with a feature combination configuration;
output signaling indicating an update to the feature combination configuration; and
output signaling indicating the updated feature combination configuration.

29. A method for wireless communications by a user equipment (UE), the method comprising:
receiving system information configuring a feature combination configuration;
receiving signaling indicating an update to the feature combination configuration; and
in response to the indication, monitoring a search space for signaling indicating the updated feature combination configuration.

30. A method for wireless communications by a network entity, the method comprising:
outputting system information configuring a user equipment (UE) with a feature combination configuration;
outputting signaling indicating an update to the feature combination configuration; and
outputting signaling indicating the updated feature combination configuration.
